(19) United States
(12) Patent Application Publication
(10) Pub. No.: US 2023/0174806 A1
(43) Pub. Date: Jun. 8, 2023

(54) MODEL MATERIAL CLEAR COMPOSITION, MODEL MATERIAL COMPOSITION SET, AND COMPOSITION SET FOR OPTICAL SHAPING

(71) Applicant: Maxell, Ltd., Kyoto (JP)

(72) Inventors: Katsuyuki KITO, Otokuni-gun, Kyoto (JP); Hiroshi OTA, Otokuni-gun, Kyoto (JP); Hiroki SAKATA, Otokuni-gun, Kyoto (JP)

(21) Appl. No.: 17/802,822

(22) PCT Filed: Mar. 10, 2021
(86) PCT No.: PCT/JP2021/009527

§ 371 Date: Aug. 26, 2022

(30) Foreign Application Priority Data
Mar. 13, 2020 (JP) 2020-044750

(51) Int. Cl. C09D 11/38; C09D 11/107; C09D 11/101; C09D 11/037; C09D 11/322; B33Y 70/00; B29C 64/40

(52) U.S. Cl. CPC C09D 11/38; B29C 64/40; B33Y 70/00; C09D 11/037; C09D 11/101; C09D 11/107; C09D 11/322; B29C 64/112

(57) ABSTRACT

The present invention provides a model material clear composition to be used in a material-jet optical shaping process, comprising an ethylenically unsaturated compound (A) and a photopolymerization initiator, wherein
the ethylenically unsaturated compound (A) comprises:
   an ethylenically unsaturated monomer (A1) having a dicyclopentenyl group and/or a dicyclopentanyl group;
   an ethylenically unsaturated compound (A2) having an aliphatic cyclic structure in a molecule and having a urethane group; and
   an ethylenically unsaturated monomer (A3) having an aliphatic cyclic structure in a molecule and having neither a urethane group nor an amide group (excluding the ethylenically unsaturated monomer (A1)), and wherein
   a total mass of the ethylenically unsaturated monomer (A1), the ethylenically unsaturated compound (A2), and the ethylenically unsaturated monomer (A3) is 60% by mass or more based on the total mass of the ethylenically unsaturated compound (A).

### TECHNICAL FIELD

The present invention relates to a model material clear composition to be used for shaping a model material by a material-jet optical shaping process, a model material composition set comprising the model material clear composition and a model material color composition, and a composition set for material-jet optical shaping comprising the model material clear composition or the model material composition set.

### BACKGROUND ART

Conventionally, a method for producing a three-dimensionally shaped article by irradiating a photocurable resin composition with light such as ultraviolet ray to form cured layers having a desired shape continuously is widely known. Particularly, a material jetting-mode (inkjet-mode) optical shaping process (hereinafter, also referred to as a “material jetting optical shaping process”) in which a photocurable resin composition is ejected through a nozzle and is then irradiated with light such as ultraviolet ray immediately after the ejection to cure the resin composition so that cured layers each having a desired shape are laminated to produce a three-dimensionally shaped article has attracted attention widely as a shaping method by which a three-dimensional shaped article can be freely produced with a 3D printer.

Photocurable resin compositions that can be used for a material-jet optical shaping process have various requirements depending on the application thereof. As one of them, a model material clear composition for obtaining a three-dimensionally shaped article having high transparency (transmissibility) and low yellowness is required. Various model material compositions have been proposed to meet such requirements. For example, Patent Document 1 describes a model material ink set comprising a clear ink that suppresses color change of a cured product by reducing the content of a nitrogen atom-containing ethylenically unsaturated monomer contained as a polymerizable compound.

### PRIOR ART DOCUMENT

### Patent Document

Patent Document 1: WO 2018/164012 A1

### SUMMARY OF THE INVENTION

### Problems to Be Solved by the Invention

Clear inks such as that described in Patent Document 1 are materials having been improved in the effect of suppressing yellowing at the time of photocuring as compared with previously proposed model material compositions and capable of providing a three-dimensionally shaped article with less yellowness. However, in recent years, a three-dimensionally shaped article obtained by a material-jet optical shaping process tends to be required to have higher appearance characteristics, and a clear model material is demanded to be further reduced in yellowness and to be further improved in transparency.

An object of the present invention is to provide a model material clear composition suitable for a material-jet optical shaping process, the composition being less likely to cause color change during photocuring and capable of providing a model material having suppressed yellowness and superior transparency.

### Solutions to the Problems

As a result of intensive studies to solve the above problems, the present inventors have found that a cured product obtained from an ethylenically unsaturated monomer (A1) having a dicyclopentenyl group and/or a dicyclopentanyl group tends not to cause yellowing due to light such as ultraviolet rays applied during curing, and have accomplished the present invention. That is, the present invention provides the following preferred embodiments.

A model material clear composition to be used in a material-jet optical shaping process, comprising an ethylenically unsaturated compound (A) and a photopolymerization initiator, wherein
the ethylenically unsaturated compound (A) comprises:
   an ethylenically unsaturated monomer (A1) having a dicyclopentenyl group and/or a dicyclopentanyl group;
   an ethylenically unsaturated compound (A2) having an aliphatic cyclic structure in a molecule and having a urethane group; and
   an ethylenically unsaturated monomer (A3) having an aliphatic cyclic structure in a molecule and having neither a urethane group nor an amide group (excluding the ethylenically unsaturated monomer (A1)), and wherein
a total mass of the ethylenically unsaturated monomer (A1), the ethylenically unsaturated compound (A2), and the ethylenically unsaturated monomer (A3) is 60% by mass or more based on the total mass of the ethylenically unsaturated compound (A).

The model material clear composition according to [1], wherein the composition comprises the ethylenically unsaturated monomer (A1) in an amount of 30% by mass or more based on the total mass of the ethylenically unsaturated compound (A).

The model material clear composition according to [1] or [2], wherein the composition comprises an ethylenically unsaturated monomer having neither an aromatic group nor a vinyl ether group as well as neither a urethane group nor an amide group as the ethylenically unsaturated monomer (A3) .

The model material clear composition according to any one of [1] to [3], wherein the ethylenically unsaturated monomer (A3) has at least one group selected from the group consisting of a cyclohexyl group, a 4-t-butylcyclohexyl group, a 3,5,5-trimethylcyclohexyl group, an isobornyl group, a tricyclodecanyl group, a dicyclopentadienyl group and a 1,4-cyclohexanedimethanol group.

The model material clear composition according to any one of [1] to [4], wherein the composition comprises the ethylenically unsaturated compound (A2) in an amount of 10% by mass or more based on the total mass of the ethylenically unsaturated compound (A).

The model material clear composition according to any one of [1] to [5], wherein the composition comprises an ethylenically unsaturated monomer having a nitrogen atom in the molecule and having no aliphatic cyclic structure in an amount of 12% by mass or less based on the total mass of the ethylenically unsaturated compound (A).

A model material composition set to be used in a material-jet optical shaping process, comprising the model material clear composition according to any one of [1] to

and a model material color composition comprising an ethylenically unsaturated monomer (B).

The model material composition set according to [7], wherein the model material color composition comprises, based on a total mass of the model material color composition, 30 to 85% by mass of a (meth)acrylate-based ethylenically unsaturated monomer (B1), and 10 to 50% by mass of a nitrogen atom-containing ethylenically unsaturated monomer (B2) that is not a (meth)acrylate-based compound.

The model material composition set according to [8], wherein the nitrogen atom-containing ethylenically unsaturated monomer (B2) that is not a (meth)acrylate-based compound is selected from the group consisting of (meth)acrylamides and N-vinyllactams.

The model material composition set according to any one of [7] to [9], wherein the model material color composition comprises a monofunctional ethylenically unsaturated monomer and a di- or more functional ethylenically unsaturated monomer as the ethylenically unsaturated monomer (B).

The model material composition set according to any one of [8] to [10], wherein the model material color composition comprises a (meth)acrylate-based ethylenically unsaturated monomer having an aliphatic cyclic structure and/or an aromatic cyclic structure as the (meth)acrylate-based ethylenically unsaturated monomer (B1).

The model material composition set according to any one of [7] to [11], wherein a constitution of the model material color composition comprises cyan, magenta and yellow.

The model material composition set according to [12], wherein the constitution of the model material color composition further comprises white and/or black.

The model material composition set according to any one of [7] to [13], wherein both the model material clear composition and the model material color composition comprise a surface conditioner.

The model material composition set according to [14], wherein a content (% by mass) of the surface conditioner contained in the model material clear composition based on a total mass of the model material clear composition is larger than a content (% by mass) of the surface conditioner contained in the model material color composition based on the total mass of the model material color composition.

A composition set for material-jet optical shaping, comprising the model material clear composition according to any one of [1] to [6] or the model material composition set according to any one of [7] to [15] and a support material composition for shaping a support material by a material-jet optical shaping process.

### Effects of the Invention

According to the present invention, it is possible to provide a model material clear composition suitable for a material-jet optical shaping process, the composition being less likely to cause color change during photocuring and capable of providing a model material having suppressed yellowness and superior transparency.

### EMBODIMENTS OF THE INVENTION

Hereinafter, embodiments of the present invention will be described in detail. The scope of the present invention is not limited to the embodiments described herein, and various modifications can be made within a scope not impairing the spirit of the present invention.

### Model Material Clear Composition

A model material clear composition of the present invention comprises an ethylenically unsaturated compound (A). The ethylenically unsaturated compound (A) is a polymerizable compound having at least one ethylenic double bond in a molecule and having a property of being cured with energy rays. The ethylenically unsaturated compound (A) may be any of a polymerizable monomer, a polymerizable oligomer, and a polymerizable polymer. The ethylenically unsaturated compound may be either a monofunctional ethylenically unsaturated compound having one ethylenic double bond in the molecule or a polyfunctional ethylenically unsaturated compound having two or more ethylenic double bonds in the molecule.

The model material clear composition of the present invention comprises, as the ethylenically unsaturated compound (A), an ethylenically unsaturated monomer (A1) having a dicyclopentenyl group and/or a dicyclopentanyl group (hereinafter, also simply referred to as “ethylenically unsaturated monomer (A1)”). Although the reason is not clear, a cured product obtained from the ethylenically unsaturated monomer (A1) having a dicyclopentenyl group and/or a dicyclopentanyl group tends to be less likely to be yellowed by light, such as ultraviolet rays, applied during curing. Therefore, when the model material composition comprises the ethylenically unsaturated monomer (A1) as a polymerizable compound, color change (particularly yellowing) at the time of curing the model material composition by irradiation with light hardly occurs, so that a model material (a optically shaped article) having a suppressed yellowness and a superior transparency can be obtained.

The ethylenically unsaturated monomer (A1) is not particularly limited as long as it is a polymerizable monomer having at least one group selected from a dicyclopentenyl group and a dicyclopentanyl group and having at least one ethylenic double bond in a molecule, and may be a monofunctional monomer or a polyfunctional monomer. Examples of the ethylenically unsaturated monomer (A1) include (meth)acrylates having a dicyclopentenyl group and/or a dicyclopentanyl group, and specific examples thereof include dicyclopentenyl acrylate, dicyclopentenyl methacrylate, dicyclopentenyloxyethyl acrylate, dicyclopentenyloxyethyl methacrylate, dicyclopentanyl acrylate, dicyclopentanyl methacrylate, ethoxylated dicyclopentenyl acrylate, ethoxylated dicyclopentenyl methacrylate, alkoxylated dicyclopentenyl acrylates, alkoxylated dicyclopentenyl methacrylates, dicyclopentanyloxyethyl acrylate, dicyclopentanyloxyethyl methacrylate, ethoxylated dicyclopentanyl acrylate, ethoxylated dicyclopentanyl methacrylate, alkoxylated dicyclopentanyl acrylates, and alkoxylated dicyclopentanyl methacrylates. Among them, (meth)acrylates having a dicyclopentenyl group and/or a dicyclopentanyl group are preferable, dicyclopentenyl acrylate, dicyclopentenyloxyethyl acrylate, dicyclopentenyl methacrylate, dicyclopentenyloxyethyl methacrylate, dicyclopentanyl acrylate, and dicyclopentanyloxyethyl acrylate are more preferable, dicyclopentenyloxyethyl acrylate, dicyclopentenyloxyethyl methacrylate, and dicyclopentanyloxyethyl acrylate are even more preferable, and dicyclopentenyloxyethyl acrylate is particularly preferable. These ethylenically unsaturated monomers (A1) may be used singly or two or more thereof may be used in combination.

In the present description, the term “(meth)acrylate” represents either or both of acrylate and methacrylate. The same applies to the term of “(meth)acrylamide”.

The content of the ethylenically unsaturated monomer (A1) in the model material clear composition of the present invention is preferably 30% by mass or more, more preferably 35% by mass or more, even more preferably 40% by mass or more, particularly preferably 41% by mass or more, and especially preferably 45% by mass or more based on the total mass of the ethylenically unsaturated compound (A). When the content of the ethylenically unsaturated monomer (A1) based on the total mass of the ethylenically unsaturated compound (A) is equal to or more than the above lower limit, the model material clear composition is superior in the effect of suppressing yellowing during photocuring, and in a resulting model material, yellowness is little and a high transparency can be achieved. Therefore, from the viewpoint of becoming easy to improve the transparency of a resulting model material, it is more preferable that the content of the ethylenically unsaturated monomer (A1) is larger. On the other hand, for example, in a model material obtained by adjusting the contents in a relationship with the ethylenically unsaturated compound (A2), the ethylenically unsaturated monomer (A3), and the like to be described later, it becomes easy to control the mechanical characteristics such as strength and hardness while suppressing yellowness and securing high transparency. Therefore, the content of the ethylenically unsaturated monomer (A1) is preferably 85% by mass or less, more preferably 80% by mass or less, even more preferably 75% by mass or less, particularly preferably 70% by mass or less, especially preferably 69% by mass or less, and still especially preferably 65% by mass or less based on the total mass of the ethylenically unsaturated compound (A).

The model material clear composition of the present invention comprises, as the ethylenically unsaturated compound (A), an ethylenically unsaturated compound (A2) having an aliphatic cyclic structure in the molecule and having a urethane group (hereinafter, also simply referred to as “ethylenically unsaturated compound (A2)”). When the model material clear composition contains the ethylenically unsaturated compound (A2), it is easy to impart desired strength and hardness to a resulting model material.

The ethylenically unsaturated compound (A2) is not particularly limited as long as it is a polymerizable compound having an aliphatic cyclic structure in the molecule and having at least one urethane group and at least one ethylenic double bond, and may be any of a monomer, an oligomer, and a polymer. In the present description, the aliphatic cyclic structure means a structure in which carbon atoms are cyclically bonded wherein a saturated or unsaturated carbocyclic ring having no aromaticity is contained, and examples thereof include a cycloalkane skeleton, a cycloalkene skeleton, an adamantane skeleton, a norbornane skeleton, an isophorone skeleton, and a tricyclodecane skeleton.

Examples of the ethylenically unsaturated compound (A2) include a urethane (meth)acrylate having an aliphatic cyclic structure as described as an example above, and a urethane (meth)acrylate oligomer having an aliphatic cyclic structure. Specific examples thereof include a urethane (meth)acrylate oligomer having a dicyclohexylmethane structure, a urethane (meth)acrylate oligomer having an isophorone structure, and a urethane (meth)acrylate oligomer having a cyclohexylmethane structure. Among them, a urethane (meth)acrylate oligomer having an aliphatic cyclic structure is preferable, a (meth)acrylate oligomer having a dicyclohexylmethane structure and a urethane (meth)acrylate oligomer having an isophorone structure are more preferable, a (meth)acrylate oligomer having a dicyclohexylmethane structure is even more preferable, and an acrylate oligomer having a dicyclohexylmethane structure is particularly preferable. By using an oligomer as the ethylenically unsaturated compound (A2), it becomes easy to obtain a model material having the strength and an appropriate degree of toughness in a well-balanced manner. These ethylenically unsaturated compounds (A2) may be used singly or two or more thereof may be used in combination.

In addition, in the present description, the “oligomer” refers to a molecule having a weight average molecular weight (M_{w}) of 500 to 10,000. The weight average molecular weight (M_{w}) of the oligomer is preferably 800 or more, and more preferably more than 1,000. The weight average molecular weight (M_{w}) means a polystyrene-equivalent weight average molecular weight measured by GPC (gel permeation chromatography).

The content of the ethylenically unsaturated compound (A2) in the model material clear composition of the present invention is preferably 10% by mass or more, more preferably 11% by mass or more, even more preferably 15% by mass or more, particularly preferably 18% by mass or more, and especially preferably 20% by mass or more based on the total mass of the ethylenically unsaturated compound (A). When the content of the ethylenically unsaturated compound (A2) based on the total mass of the ethylenically unsaturated compound (A) is equal to or more than the above-mentioned lower limit, the strength and hardness of a resulting model material are readily improved. On the other hand, for example, in order to sufficiently obtain the effect of suppressing coloring (yellowing) and the effect of improving transparency of the model material by using the ethylenically unsaturated monomer (A1) as a polymerizable compound, the content of the ethylenically unsaturated compound (A2) is preferably 50% by mass or less, more preferably 45% by mass or less, even more preferably 40% by mass or less, particularly preferably 35% by mass or less, especially preferably 29% by mass or less, and still especially preferably 25% by mass or less based on the total mass of the ethylenically unsaturated compound (A) .

In the model material clear composition of the present invention, the mass ratio of the ethylenically unsaturated monomer (A1) to the ethylenically unsaturated compound (A2) [ethylenically unsaturated monomer (A1)/ethylenically unsaturated compound (A2)] can be appropriately determined according to the type of the polymerizable compound to be used, the desired mechanical characteristics of the model material. The mass ratio of the ethylenically unsaturated monomer (A1) to the ethylenically unsaturated compound (A2) is, for example, preferably 1.1 or more, more preferably 1.5 or more, and even more preferably 2 or more, and is preferably 10 or less, more preferably 8 or less, even more preferably 7 or less, and particularly preferably 5 or less. When the mass ratio of the ethylenically unsaturated monomer (A1) to the ethylenically unsaturated compound (A2) is within the above range, high transparency is secured with little yellowness in a resulting model material, and well-balanced mechanical characteristics are readily imparted to the model material.

When the model material clear composition contains a plurality of ethylenically unsaturated monomers (A1) and/or a plurality of ethylenically unsaturated compounds (A2), it is preferable that the mass ratio in the total mass of the respective polymerizable compounds is within the above range.

The model material clear composition of the present invention comprises, as the ethylenically unsaturated compound (A), an ethylenically unsaturated monomer (A3) having an aliphatic cyclic structure in the molecule and having neither a urethane group nor an amide group (hereinafter, also simply referred to as “ethylenically unsaturated monomer (A3)”). The ethylenically unsaturated monomer (A3) does not include the ethylenically unsaturated monomer (A1). Similarly to the ethylenically unsaturated compound (A2), the ethylenically unsaturated monomer (A3) can serve as a component that increases the glass transition temperature of a model material clear composition, and therefore it readily imparts desired strength and hardness to a resulting model material. By using the ethylenically unsaturated compound (A2) and the ethylenically unsaturated monomer (A3) in combination, it is easy to impart high strength or hardness and an appropriate degree of toughness to a resulting model material while sufficiently securing the effect of suppressing coloring (yellowing) and the effect of improving the transparency of the model material, both the effects being derived from the use of the ethylenically unsaturated monomer (A1). This makes it possible to obtain a model material that is less yellowish, has high transparency, is superior in appearance characteristics, and has well-balanced mechanical characteristics.

The ethylenically unsaturated monomer (A3) is not particularly limited as long as it is a polymerizable compound having an aliphatic cyclic structure in the molecule, having neither a urethane group nor an amide group, and having at least one ethylenic double bond, and it may be a monofunctional monomer or alternatively may be a polyfunctional monomer. Examples of the aliphatic cyclic structure of the ethylenically unsaturated monomer (A3) include the same structures as the aliphatic cyclic structures of the ethylenically unsaturated compound (A2). Examples of the ethylenically unsaturated monomer (A3) include a monofunctional (meth)acrylate having an aliphatic cyclic structure other than a cyclopentenyl group and a cyclopentanyl group and containing neither a urethane group nor an amide group, and a di- or more functional (meth)acrylate having an aliphatic cyclic structure other than a cyclopentenyl group and a cyclopentanyl group and containing neither a urethane group nor an amide group.

In the present invention, the ethylenically unsaturated monomer (A3) is preferably an ethylenically unsaturated monomer having neither an aromatic group nor a vinyl ether group as well as neither a urethane group nor an amide group. The ethylenically unsaturated monomer (A3) preferably has at least one group selected from the group consisting of a cyclohexyl group, a 4-t-butylcyclohexyl group, a 3,5,5-trimethylcyclohexyl group, an isobornyl group, a tricyclodecanyl group, a dicyclopentadienyl group, and a 1,4-cyclohexanedimethanol group, and more preferably contains neither a urethane group nor an amide group as well as neither an aromatic group nor a vinyl ether group and has at least one group selected from the group consisting of a cyclohexyl group, a 4-t-butylcyclohexyl group, a 3,5,5-trimethylcyclohexyl group, an isobornyl group, a tricyclodecanyl group, a dicyclopentadienyl group and a 1,4-cyclohexanedimethanol group. When the ethylenically unsaturated monomer (A3) has the structure described above, the glass transition temperature of the model material clear composition readily increases, and desired strength and hardness are readily imparted to a resulting model material.

Specific examples of the ethylenically unsaturated monomer (A3) include cyclohexyl acrylate, 4-t-butylcyclohexyl acrylate, 3,5,5-trimethylcyclohexyl acrylate, isobornyl acrylate, tricyclodecanedimethanol diacrylate, dicyclopentadienyl methacrylate, and 1,4-cyclohexanedimethanol monoacrylate. Among them, it is preferable that the ethylenically unsaturated monomer (A3) comprises one selected from the group consisting of cyclohexyl acrylate, 4-t-butylcyclohexyl acrylate, 3,5,5-trimethylcyclohexyl acrylate, isobornyl acrylate, tricyclodecanedimethanol diacrylate, and 1,4-cyclohexanedimethanol monoacrylate; and 3,5,5-trimethylcyclohexyl acrylate and/or isobornyl acrylate are more preferable. These ethylenically unsaturated monomers (A3) may be used singly or two or more thereof may be used in combination.

The content of the ethylenically unsaturated monomer (A3) in the model material clear composition of the present invention is preferably 5% by mass or more, more preferably 10% by mass or more, even more preferably 15% by mass or more, and particularly preferably 21% by mass or more based on the total mass of the ethylenically unsaturated compound (A). When the content of the ethylenically unsaturated monomer (A3) based on the total mass of the ethylenically unsaturated compound (A) is equal to or more than the above-mentioned lower limit, the strength and hardness of a resulting model material are readily improved. On the other hand, for example, in order to sufficiently obtain the effect of suppressing coloring (yellowing) and the effect of improving transparency of a model material, both the effects being derived from the use of the ethylenically unsaturated monomer (A1) as the polymerizable compound, the content of the ethylenically unsaturated monomer (A3) is preferably 50% by mass or less, more preferably 45% by mass or less, even more preferably 40% by mass or less, particularly preferably 35% by mass or less, and especially preferably less than 30% by mass based on the total mass of the ethylenically unsaturated compound (A).

In the model material clear composition of the present invention, the mass ratio of the ethylenically unsaturated monomer (A1) to the ethylenically unsaturated monomer (A3) [ethylenically unsaturated monomer (A1)/ethylenically unsaturated monomer (A3)] can be appropriately determined according to the type of the polymerizable compound to be used and the desired mechanical characteristics of the model material. The mass ratio of the ethylenically unsaturated monomer (A1) to the ethylenically unsaturated monomer (A3) is preferably 1.5 or more, more preferably 1.8 or more, and even more preferably more than 2, and is preferably 10 or less, more preferably 8 or less, even more preferably 7 or less, and particularly preferably 5 or less. When the mass ratio of the ethylenically unsaturated monomer (A1) to the ethylenically unsaturated monomer (A3) is within the above range, it becomes easy to impart well-balanced mechanical characteristics to a resulting model material while securing a high transparency with suppressed yellowness in the model material.

When the model material clear composition contains a plurality of ethylenically unsaturated monomers (A1) and/or a plurality of ethylenically unsaturated monomers (A3), it is preferable that the mass ratio in the total mass of the respective polymerizable compounds is within the above range.

In the model material clear composition of the present invention, the mass ratio of the ethylenically unsaturated compound (A2) to the ethylenically unsaturated monomer (A3) [ethylenically unsaturated compound (A2)/ethylenically unsaturated monomer (A3)] can be appropriately determined according to the type of the polymerizable compound to be used and the desired mechanical characteristics of the model material. The mass ratio of the ethylenically unsaturated compound (A2) to the ethylenically unsaturated monomer (A3) is preferably 0.5 or more, and more preferably 0.8 or more, and is preferably 2.5 or less, more preferably 2 or less, and even more preferably 1.4 or less. When the mass ratio of the ethylenically unsaturated compound (A2) to the ethylenically unsaturated monomer (A3) is within the above range, high strength or hardness and an appropriate degree of toughness are readily imparted to a resulting model material.

When the model material clear composition contains a plurality of ethylenically unsaturated compounds (A2) and/or a plurality of ethylenically unsaturated monomers (A3), it is preferable that the mass ratio in the total mass of the respective polymerizable compounds is within the above range.

In the model material clear composition of the present invention, the mass ratio of the total mass of the ethylenically unsaturated monomer (A1) to the total mass of the ethylenically unsaturated compound (A2) and the ethylenically unsaturated monomer (A3) [ethylenically unsaturated monomer (A1)/ethylenically unsaturated compound (A2) + ethylenically unsaturated monomer (A3)] can be appropriately determined according to the type of the polymerizable compound to be used and the desired mechanical characteristics of the model material. The mass ratio is preferably 0.5 or more, more preferably 0.9 or more, even more preferably 1 or more, and particularly preferably more than 1, and is preferably 4 or less, more preferably 3 or less, and even more preferably 2 or less. When the mass ratio of the ethylenically unsaturated monomer (A1) to the ethylenically unsaturated compound (A2) and the ethylenically unsaturated monomer (A3) is within the above range, it becomes easy to impart well-balanced mechanical characteristics to a resulting model material while securing a high transparency with little yellowness in the model material.

In the model material clear composition of the present invention, the total mass of the ethylenically unsaturated monomer (A1), the ethylenically unsaturated compound (A2), and the ethylenically unsaturated monomer (A3) is preferably 60% by mass or more based on the total mass of the ethylenically unsaturated compound (A). When the total mass of the aforementioned three polymerizable compounds each having an aliphatic cyclic structure in the molecule is equal to or more than the above-mentioned lower limit, high transparency is secured with little yellowness in a resulting model material, and well-balanced mechanical characteristics are readily imparted to the model material. The total mass of the aforementioned three polymerizable compounds is more preferably 65% by mass or more, even more preferably 70% by mass or more, and particularly preferably 75% by mass or more based on the total mass of the ethylenically unsaturated compound (A). The upper limit of the total mass of the three polymerizable compounds is not particularly limited, and the ethylenically unsaturated compound (A) may be composed of only the three polymerizable compounds (that is, 100% by mass), and may be, for example, 95% by mass or less or 90% by mass or less.

The model material clear composition of the present invention may comprise, as the ethylenically unsaturated compound (A), an ethylenically unsaturated compound (A4) other than the ethylenically unsaturated monomer (A1), the ethylenically unsaturated compound (A2) and the ethylenically unsaturated monomer (A3) (hereinafter, also simply referred to as “ethylenically unsaturated compound (A4)”). The ethylenically unsaturated compound (A4) is not particularly limited as long as it is a polymerizable compound that has at least one ethylenic double bond in the molecule and that is different from the ethylenically unsaturated monomer (A1), the ethylenically unsaturated compound (A2), and the ethylenically unsaturated monomer (A3), and may be any of a monomer, an oligomer, and a polymer. In addition, it may be monofunctional or polyfunctional.

Examples of the ethylenically unsaturated compound (A4) include ethylenically unsaturated compounds having no aliphatic cyclic structure in the molecule, such as alkyl (meth)acrylates having a linear or branched alkyl group; (meth)acrylates having an aromatic cyclic structure or a heterocyclic structure in the molecule; and monofunctional ethylenically unsaturated monomers containing a nitrogen atom, such as (meth)acrylamides and N-vinyllactams. Specific examples include alkyl (meth)acrylates and (meth)acrylates having an aromatic cyclic structure or a heterocyclic structure in the molecule that will be described as examples of the (meth)acrylate-based ethylenically unsaturated monomer (B1) that may be contained in the model material color composition to be described below, and compounds that will be described as examples of the nitrogen atom-containing ethylenically unsaturated monomer (B2). These ethylenically unsaturated compounds (A4) may be used singly or two or more thereof may be used in combination. In the present description, the aromatic ring structure refers to an aromatic cyclic structure in which carbon atoms are cyclically bonded, and the heterocyclic structure refers to a structure in which carbon atoms and one or more heteroatoms are cyclically bonded.

In one embodiment of the present invention, when the ethylenically unsaturated compound (A) comprises the ethylenically unsaturated compound (A4), the content of the ethylenically unsaturated compound (A4) is preferably 38% by mass or less, more preferably 20% by mass or less, even more preferably 15% by mass or less, and particularly preferably 12% by mass or less based on the total mass of the ethylenically unsaturated compound (A). When the content of the ethylenically unsaturated compound (A4) is equal to or less than the above upper limit, high transparency is secured with little yellowness in a resulting model material, and well-balanced mechanical characteristics are readily imparted to the model material. The lower limit value of the content of the ethylenically unsaturated compound (A4) is not particularly limited, and in another embodiment of the present invention, the model material clear composition may contain substantially no ethylenically unsaturated compound (A4), and the content may be, for example, 1% by mass or more, or 3% by mass or more, or 5% by mass or more based on the total mass of the ethylenically unsaturated compound (A).

In one embodiment of the present invention, when the ethylenically unsaturated compound (A) comprises the ethylenically unsaturated compound (A4), the ethylenically unsaturated compound (A4) is preferably an ethylenically unsaturated monomer (A4′) having a nitrogen atom in the molecule and having no aliphatic cyclic structure (hereinafter, also simply referred to as “ethylenically unsaturated monomer (A4′)”). When the ethylenically unsaturated monomer (A4′) is used, the hardness of a resulting model material is readily improved. As the ethylenically unsaturated monomer (A4′), compounds described as examples of the nitrogen atom-containing ethylenically unsaturated monomer (B2) that may be contained in the model material color composition to be described below, and the like can be used, and examples thereof include (meth)acrylamides [e.g., N,N-dimethylacrylamide, N,N-diethylacrylamide, N-isopropylacrylamide, hydroxyethylacrylamide, hydroxypropylacrylamide, and acryloylmorpholine], N-vinyllactams [e.g., N-vinylpyrrolidone and N-vinylcaprolactam], and N-vinylformamide. These may be used singly or two or more thereof may be used in combination. Among them, acryloylmorpholine is preferable because it has a high glass transition temperature and a high curability, so that a high hardness can be imparted to a resulting model material. In addition, since acryloylmorpholine suitably functions as a diluent, an oligomer component such as the ethylenically unsaturated compound (A2), which is useful for improving the brittling resistance of a resulting model material, can be blended more in the model material clear composition while maintaining the viscosity of the model material clear composition in an appropriate range. Therefore, by containing acryloylmorpholine, a model material having both a high hardness and an appropriate toughness in a well-balanced manner can be obtained.

In one embodiment of the present invention, when the ethylenically unsaturated compound (A) comprises the ethylenically unsaturated monomer (A4′), the content of the ethylenically unsaturated monomer (A4′) is preferably 12% by mass or less, more preferably 11% by mass or less, and even more preferably 10.5% by mass or less based on the total mass of the ethylenically unsaturated compound (A). When the content of the ethylenically unsaturated monomer (A4′) is equal to or less than the above upper limit, the effect of enhancing the strength by the ethylenically unsaturated monomer (A4′) is readily obtained while maintaining high transparency with little yellowness in a resulting model material. The ethylenically unsaturated monomer (A4′) generally tends to readily turn yellowish upon photoirradiation as compared to nitrogen-free polymerizable compounds. By virtue of the use of the ethylenically unsaturated monomer (A1) as a polymerizable compound, the model material clear composition of the present invention is superior in the effect of suppressing coloring (yellowing) and the effect of improving transparency of a resulting model material, and therefore can contain a relatively large amount of the ethylenically unsaturated monomer (A4′), which is prone to cause yellowing. Therefore, the lower limit of the content of the ethylenically unsaturated monomer (A4′) is not particularly limited, and may be, for example, 1% by mass or more, or may be 3% by mass or more, or may be 5% by mass or more, based on the total mass of the ethylenically unsaturated compound (A).

In another embodiment of the present invention, the content of the ethylenically unsaturated monomer (A4′) in the model material clear composition may be, for example, 5% by mass or less, or may be 3% by mass or less, or may be 1% by mass or less, based on the total mass of the ethylenically unsaturated compound (A). Also, the model material clear composition may not contain the ethylenically unsaturated monomer (A4′).

The model material clear composition of the present invention may comprise a polymerizable compound other than the ethylenically unsaturated compound (A) as a polymerizable compound. Examples of such other polymerizable compound include oxygen-containing cyclic compounds such as oxirane compounds and oxetane compounds, and nitrogen-containing cyclic compounds such as aziridine compounds and acetidine compounds. When the model material clear composition of the present invention comprises a polymerizable compound other than the ethylenically unsaturated compound (A), the content thereof is preferably 15% by mass or less, more preferably 10% by mass or less, and even more preferably 5% by mass or less based on the total mass of the ethylenically unsaturated compound (A).

The content of the ethylenically unsaturated compound (A) in the model material clear composition of the present invention is preferably 80% by mass or more, more preferably 85% by mass or more, and even more preferably 90% by mass or more based on the total mass of the model material clear composition. When the content of the ethylenically unsaturated compound (A) in a model material clear composition is equal to or more than the above-mentioned lower limit, a model material clear composition that tends to impart a high transparency with suppressed yellowness and well-balanced mechanical characteristics to a resulting model material is obtained. The upper limit of the content of the ethylenically unsaturated compound (A) is not particularly limited, but is usually 99% by mass or less, and preferably 98% by mass or less based on the total mass of the model material clear composition.

The content of the polymerizable compounds in the model material clear composition of the present invention is preferably 90% by mass or more, and more preferably 95% by mass or more, and is preferably 99.9% by mass or less, and more preferably 99.5% by mass or less based on the total mass of the model material clear composition.

The model material clear composition of the present invention comprises a photopolymerization initiator. The photopolymerization initiator is not particularly limited as long as it is a compound that promotes a radical reaction when being irradiated with ultraviolet rays, near ultraviolet rays or light having a wavelength in the visible light region. Examples of the photopolymerization initiator include benzoin compounds [e.g., benzoin, benzoin methyl ether, benzoin ethyl ether, benzoin propyl ether, and benzoin isobutyl ether], acetophenone compounds [e.g., acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxy acetophenone, 1-hydroxycyclohexyl phenyl ketone, and 2-methyl-1-[4-(methylthio)phenyl]-2-morpholinopropan-1-one], anthraquinone compounds [e.g., 2-ethylanthraquinone, 2-t-butylanthraquinone, 2-chloroanthraquinone, and 2-amylanthraquinone], thioxanthone compounds [e.g., 2,4-diethylthioxanthone, 2-isopropylthioxanthone, and 2-chlorothioxanthone], ketal compounds [e.g., acetophenonedimethylketal and benzyldimethylketal], benzophenone compounds [e.g., benzophenone, 4-benzoyl-4′-methyldiphenyl sulfide, and 4,4′-bismethylaminobenzophenone], acylphosphine oxide compounds [e.g., 2,4,6-trimethylbenzoyl-diphenyl-phosphine oxide, bis-(2,6-dimethoxybenzoyl)-2,4,4-trimethylpentylphosphine oxide, and bis(2,4,6-trimethylbenzoyl)-phenylphosphine oxide], and mixtures of these compounds. These may be used singly or two or more thereof may be used in combination. Among these, from the viewpoint that a model material obtained when the model material ink is photocured is less prone to yellow and the viewpoint that the resulting model material has high light resistance and the like and is less prone to turn yellowish over time, the photopolymerization initiator preferably comprises at least one compound selected from the group consisting of acetophenone compounds and acylphosphine oxide compounds, and more preferably comprises at least one compound selected from the group consisting of 1-hydroxycyclohexyl phenyl ketone, 2-hydroxy-2-methyl-1-phenyl-propan-1-one, and 2,4,6-trimethylbenzoyl-diphenylphosphine oxide. As the photopolymerization initiator, a commercially available product may be used, and examples thereof include IRGACURE TPO available from BASF SE.

The content of the photopolymerization initiator in the model material clear composition is preferably 0.1% by mass or more, more preferably 0.5% by mass or more, and even more preferably 1% by mass or more, and is preferably 15% by mass or less, more preferably 10% by mass or less, and even more preferably 8% by mass or less based on the total mass of the model material clear composition. When the content of the photopolymerization initiator is within the above range, unreacted polymerizable components can be reduced and the curability of the model material is sufficiently enhanced, as well as yellowing with time of the model material caused by remaining of the unreacted photopolymerization initiator can be suppressed.

The model material clear composition may comprise, as necessary, other additives unless the effects of the present invention are impaired. Examples of such other additives include storage stabilizers, surface conditioners, antioxidants, ultraviolet absorbing agents, light stabilizers, polymerization inhibitors, chain transfer agents, fillers, dilution solvents, and thickeners.

The surface conditioner is a component that adjusts the surface tension of the model material clear composition to an appropriate range, and the type thereof is not particularly limited. By setting the surface tension of the model material clear composition to an appropriate range, the jettability can be stabilized and the interface mixing between the model material clear composition and the model material color composition and/or the support material composition can be suppressed. As a result, a model material with a good dimensional accuracy can be obtained.

Examples of the surface conditioner include silicone-based compounds. Examples of the silicone-based compounds include silicone-based compounds having a polydimethylsiloxane structure. Specific examples thereof include polyether-modified polydimethylsiloxane, polyester-modified polydimethylsiloxane, and polyaralkyl-modified polydimethylsiloxane. As these, products available under the trade names BYK-300, BYK-302, BYK-306, BYK-307, BYK-310, BYK-315, BYK-320, BYK-322, BYK-323, BYK-325, BYK-330, BYK-331, BYK-333, BYK-337, BYK-344, BYK-370, BYK-375, BYK-377, BYK-UV3500, BYK-UV3510, BYK-UV3570 (manufactured by BYK-Chemie GmbH), TEGO-Rad 2100, TEGO-Rad 2200N, TEGO-Rad 2250, TEGO-Rad 2300, TEGO-Rad 2500, TEGO-Rad 2600, TEGO-Rad 2700 (manufactured by Degussa AG), Granol 100, Granol 115, Granol 400, Granol 410, Granol 435, Granol 440, Granol 450, B-1484, POLYFLOW ATF-2, KL-600, UCR-L72, UCR-L93 (manufactured by KYOEISHA CHEMICALS Co., LTD.) and the like may be used. In addition, a surface conditioner other than the silicone-based compound (for example, a fluorine-based surface conditioner) may be used. These may be used singly or two or more thereof may be used in combination.

When the model material clear composition contains a surface conditioner, the content thereof is preferably 0.005% by mass or more, more preferably 0.01% by mass or more, and even more preferably 0.05% by mass or more, and is preferably 3% by mass or less, more preferably 2% by mass or less, and even more preferably 1.5% by mass or less based on the total mass of the model material clear composition. When the content of the surface conditioner is within the above-mentioned range, it is easy to adjust the surface tension of the model material clear composition to an appropriate range.

When the model material clear composition of the present invention is used together with a model material color composition described below, the amount of the surface conditioner contained in the model material clear composition (i.e., the content (% by mass) of the surface conditioner based on the total mass of the model material clear composition) is preferably larger than the amount of the surface conditioner contained in the model material color composition (the content (% by mass) of the surface conditioner based on the total mass of the model material color composition). When the amount of the surface conditioner contained in the model material clear composition is larger than the amount of the surface conditioner contained in the model material color composition, repelling between the model material clear composition and the model material color composition at the interface is suppressed. As a result, a clear boundary between the clear model material and the color model material is formed in a resulting model material, so that a model material superior in appearance can be obtained. In this case, the amount of the surface conditioner contained in the model material clear composition may be appropriately determined according to the types, proportions, and the like of the polymerizable compounds constituting the model material clear composition and the model material color composition. In one embodiment of the present invention, the amount (% by mass) of the surface conditioner contained in the model material clear composition is preferably 1.2 times or more, more preferably 1.5 times or more, and even more preferably 1.8 times or more, and is preferably 3 times or less, more preferably 2.8 times or less, and even more preferably 2.5 times or less based on the amount (% by mass) of the surface conditioner contained in the model material color composition.

The storage stabilizer is an ingredient that can enhance storage stability of a model material clear composition. Additionally, head clogging caused by polymerization of a polymerizable compound with heat energy can be prevented. Examples of the storage stabilizer include hindered amine-based compounds (HALS), phenolic antioxidants, and phosphorus-based antioxidants. Specific examples of the storage stabilizer include hydroquinone, methoquinone, benzoquinone, p-methoxyphenol, hydroquinone monomethyl ether, hydroquinone monobutyl ether, TEMPO, 4-hydroxy-TEMPO, TEMPOL, Cupferron AI, IRGASTAB UV-10, IRGASTAB UV-22, FIRSTCURE ST-1 (manufactured by ALBEMARLE Corporation), t-butylcatechol, pyrogallol, TINUVIN 111 FDL, TINUVIN 144, TINUVIN 292, TINUVIN XP40, TINUVIN XP60, and TINUVIN 400 manufactured by BASF SE. These may be used singly or two or more thereof may be used in combination.

When the model material clear composition contains a storage stabilizer, the content thereof is preferably 0.01 to 5% by mass based on the total mass of the model material clear composition from the viewpoint of being easy to obtain the above effect.

The model material clear composition of the present invention usually does not contain a coloring agent or contains a pigment and/or dye such as a bluing agent only in a small amount. Therefore, the content of the coloring agent in the model material clear composition of the present invention is usually 0.1% by mass or less, and more preferably 0.05% by mass or less based on the total mass of the model material clear composition, and the lower limit thereof is 0% by mass or more.

The model material clear composition of the present invention preferably has a viscosity of 1 mPa·s or more and less than 500 mPa·s at 25° C. for use in a material-jet optical shaping process. The viscosity at 25° C. is preferably 10 to 400 mPa·s, and more preferably 20 to 300 mPa·s from the viewpoint of improving jettability from a material jetting nozzle. The viscosity can be measured using a R100 type viscometer in accordance with JIS Z 8803. The viscosity of the model material clear composition can be controlled by adjusting the type and blending ratio of a polymerizable compound, and the type and addition amount of a dilution solvent and a thickener.

The surface tension of the model material clear composition of the present invention is preferably from 24 to 34 mN/m, and more preferably from 28 to 30 mN/m. When the surface tension is within the above range, the droplet jetted through a nozzle can be normally formed even at the time of high-speed jetting in material jet, an appropriate droplet amount is easily secured, and it becomes easy to improve the shaping accuracy. In the present invention, the surface tension of the model material clear composition can be controlled by adjusting the type and blending amount of the surface conditioner.

The method for producing the model material clear composition of the present invention is not particularly limited, and for example, the model material clear composition can be produced by uniformly mixing components which make up the model material clear composition using a mixing and stirring device.

### Model Material Composition Set

The model material clear composition of the present invention is suitable for the preparation of a colorless model material superior in transparency, and can provide a model material having various appearances and surface textures in combination with the model material color composition. Therefore, the present invention is also directed to a model material composition set comprising the model material clear composition of the present invention and a model material color composition.

The model material clear composition of the present invention can be used in combination with various conventionally known model material color compositions. The model material color composition that can be suitably used together with the model material clear composition of the present invention may be a model material color composition comprising an ethylenically unsaturated monomer (B), or preferably comprising, based on the total mass of the model material color composition, 30 to 85% by mass of a (meth)acrylate-based ethylenically unsaturated monomer (B1) and 10 to 50% by mass of a nitrogen atom-containing ethylenically unsaturated monomer (B2) that is not a (meth)acrylate-based compound.

The model material color composition contained in the model material composition set of the present invention comprises an ethylenically unsaturated monomer (B). The ethylenically unsaturated monomer (B) is a polymerizable monomer having at least one ethylenic double bond in the molecule and having a property of being cured with energy rays. The ethylenically unsaturated monomer (B) may be either a monofunctional ethylenically unsaturated monomer having one ethylenic double bond in the molecule or a polyfunctional ethylenically unsaturated monomer having two or more ethylenic double bonds in the molecule. Examples of the ethylenically unsaturated monomer (B) include (meth)acrylates, (meth)acrylamides, N-vinyllactams, vinyl ethers, and maleimides.

The model material color composition contained in the model material composition set of the present invention preferably comprises a (meth)acrylate-based ethylenically unsaturated monomer (B1) (hereinafter, also simply referred to as “ethylenically unsaturated monomer (B1)”) as the ethylenically unsaturated monomer (B). The ethylenically unsaturated monomer (B1) may be a monofunctional (meth)acrylate (monofunctional ethylenically unsaturated monomer), or a polyfunctional (meth)acrylate (polyfunctional ethylenically unsaturated monomer). Examples of the (meth)acrylate include alkyl (meth)acrylates having a linear or branched alkyl group, (meth)acrylates having an aliphatic cyclic structure and/or an aromatic cyclic structure in the molecule, (meth)acrylates having a heterocyclic structure, (meth)acrylates having a linear or branched alkylene group, and alkylene glycol (meth)acrylates having a linear or branched alkylene glycol group. These may be used singly or two or more thereof may be used in combination.

Examples of the linear or branched alkyl group in the alkyl (meth)acrylates include preferably alkyl groups having 4 to 30 carbon atoms, and more preferably those having 6 to 25 carbon atoms, and specific examples thereof include an octyl group, an isooctyl group, a 2-ethylhexyl group, a nonyl group, an isononyl group, a lauryl group, a stearyl group, an isostearyl group, and a t-butyl group. The alkyl (meth)acrylate is usually a monofunctional (meth)acrylate.

The (meth)acrylate having an aliphatic cyclic structure and/or an aromatic cyclic structure has an alicyclic group and/or an aromatic hydrocarbon group in the molecule. Examples of these groups preferably include alicyclic groups and aromatic hydrocarbon groups having 6 to 20 carbon atoms, and more preferably include those having 8 to 14 carbon atoms. Examples of the alicyclic group include a cyclohexyl group, a 4-t-butylcyclohexyl group, an isobornyl group, a dicyclopentanyl group, a tricyclodecyl group, and an adamantyl group. Examples of the aromatic hydrocarbon group include a phenoxyethyl group, an ethoxylated phenyl group (e.g., a 2-(2-ethoxyethoxy)phenyl) group, a phenylphenol group, and a fluorene group. The (meth)acrylate having an aliphatic cyclic structure and/or an aromatic cyclic structure may be either monofunctional or polyfunctional, but it is preferably a monofunctional (meth)acrylate.

The (meth)acrylate having a heterocyclic structure has a heterocyclic group in the molecule. Examples of the heterocyclic group preferably include heterocyclic groups having 5 to 20 carbon atoms, and more preferably include those having 5 to 14 carbon atoms. Examples of the (meth)acrylates having a heterocyclic structure include tetrahydrofurfuryl (meth)acrylate, 4-(meth)acryloyloxymethyl-2-methyl-2-ethyl-1,3-dioxolane, and 4-(meth)acryloyloxymethyl-2-cyclohexyl-1,3-dioxolane. The (meth)acrylate having a heterocyclic structure may be either monofunctional or polyfunctional, but it is preferably a monofunctional (meth)acrylate.

Examples of the alkylene group in the (meth)acrylate having a linear or branched alkylene group preferably include alkylene groups having 2 to 30 carbon atoms, and more preferably include those having 3 to 20 carbon atoms. Examples of such alkylene groups include a pentaerythritol group, a dipentaerythritol group, and a dimethyloltricyclodecane group. Examples of the (meth)acrylate having a linear or branched alkylene group include specifically pentaerythritol tri(meth)acrylate, dipentaerythritol hexa(meth)acrylate, and dimethyloltricyclodecane di(meth)acrylate. The (meth)acrylate having a linear or branched alkylene group is usually a polyfunctional (meth)acrylate, and is preferably a polyfunctional (meth)acrylate having 2 to 10, and more preferably 2 to 6 (meth)acrylate groups.

Examples of the alkylene glycol group in the (meth)acrylate having a linear or branched alkylene glycol group preferably include alkylene glycol groups having 4 to 25 carbon atoms, and more preferably include those having 6 to 20 carbon atoms. Examples of the alkylene glycol group include a tripropylene glycol group, a 1,6-hexanediol group, a neopentyl glycol group, a 1,9-nonanediol group, a 3-methyl-1,5-pentanediol group, a 2-n-butyl-2-ethyl-1,3-propanediol group, a pentaerythritol group, (n)ethylene glycol groups such as a diethylene glycol group and a triethylene glycol group, and (n)propylene glycol groups such as a dipropylene glycol group and a tripropylene glycol group. Examples of the (meth)acrylate having a linear or branched alkylene glycol group include specifically di(meth)acrylates of the above-mentioned alkylene glycols and tri(meth)acrylates of the above-mentioned alkylene glycols. The (meth)acrylate having a linear or branched alkylene glycol group may be either monofunctional or polyfunctional, but it is preferably a polyfunctional (meth)acrylate having 1 to 6, and more preferably 2 or 3 (meth)acrylate groups.

From the viewpoint of readily decreasing the viscosity of a model material color composition and readily enhancing the jettability in material jetting and from the viewpoint of readily enhancing the strength and hardness of a resulting model material, the composition preferably comprises, as the ethylenically unsaturated monomer (B1), a (meth)acrylate-based ethylenically unsaturated monomer having an aliphatic cyclic structure and/or an aromatic cyclic structure, more preferably comprises a (meth)acrylate-based ethylenically unsaturated monomer having an aliphatic cyclic structure, and even more preferably comprises isobornyl (meth)acrylate and/or cyclohexyl (meth)acrylate.

The content of the ethylenically unsaturated monomer (B1) contained in the model material color composition is preferably 30% by mass or more, more preferably 35% by mass or more, even more preferably 40% by mass or more, and particularly preferably 45% by mass or more, and is preferably 85% by mass or less, more preferably 75% by mass or less, even more preferably 70% by mass or less, and particularly preferably 65% by mass or less based on the total mass of the model material color composition. When the content of the ethylenically unsaturated monomer (B1) is equal to or more than the above-mentioned lower limit, the viscosity of the model material color composition is easily controlled, and a good jettability from a nozzle is easily secured. When the content of the ethylenically unsaturated monomer (B1) is equal to or less than the above-mentioned upper limit, high strength and hardness are easily imparted to a resulting model material, and dimensional stability of the model material may be improved.

The model material color composition contained in the model material composition set of the present invention preferably comprises a nitrogen atom-containing ethylenically unsaturated monomer (B2) that is not a (meth)acrylate-based compound (hereinafter, also simply referred to as “nitrogen atom-containing ethylenically unsaturated monomer (B2)”) as the ethylenically unsaturated monomer (B). In the present description, the ethylenically unsaturated monomer (B2) is not a (meth)acrylate, and the nitrogen atom-containing ethylenically unsaturated monomer (B2) does not encompass any (meth)acrylate having a nitrogen atom.

The nitrogen atom-containing ethylenically unsaturated monomer (B2) contained in the model material color composition may be either a monofunctional nitrogen atom-containing ethylenically unsaturated monomer (monofunctional ethylenically unsaturated monomer), or a polyfunctional nitrogen atom-containing ethylenically unsaturated monomer (polyfunctional ethylenically unsaturated monomer). Examples of the nitrogen atom-containing ethylenically unsaturated monomer (B2) include (meth)acrylamides, N-vinyllactams, maleimides, and N-vinylformamide. These may be used singly or two or more thereof may be used in combination.

Examples of the (meth)acrylamides include monofunctional or polyfunctional (meth)acrylamide compounds represented by the following Formula (I):

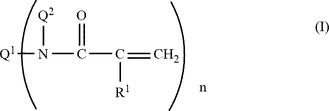

wherein, Q¹ represents an n-valent linking group, Q² each independently represents a hydrogen atom or a monovalent organic group, R¹ each independently represents a hydrogen atom or a methyl group, and n represents an integer of 1 or 2 or more, and
monofunctional compounds represented by the following Formula (II):

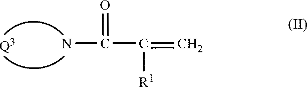

wherein, Q³ represents an optionally substituted divalent linking group which forms an alicyclic structure together with an N atom, and R¹ represents a hydrogen atom or a methyl group.

From the viewpoint of being easy to appropriately decrease the viscosity of the model material color composition to improve the jettability of the composition, the (meth)acrylamide is preferably monofunctional.

Examples of the monofunctional compounds represented by the Formula (I) and the Formula (II) include (meth)acrylamides wherein Q¹ in the Formula (I) is preferably a linear or branched alkyl group having 1 to 10 carbon atoms, and Q² is preferably a linear or branched alkyl group having 1 to 10 carbon atoms and/or a hydrogen atom [e.g., N,N-dimethylacrylamide, N,N-diethylacrylamide, and N-isopropylacrylamide], hydroxyalkyl(meth)acrylamides wherein Q¹ in the Formula (I) preferably has a linear or branched hydroxyalkyl group having 2 to 10 carbon atoms, and Q² is a hydrogen atom [e.g., hydroxyethylacrylamide and hydroxypropylacrylamide], (meth)acrylamides wherein Q¹ in the Formula (I) preferably has an alicyclic group having 3 to 20 carbon atoms and Q² is preferably a linear or branched alkyl group having 1 to 10 carbon atoms and/or a hydrogen atom, and (meth)acrylamides wherein Q³ in the Formula (II) preferably has 4 to 20 carbon atoms and constitutes an alicyclic group [e.g., acryloylmorpholine].

The N-vinyllactams may be either monofunctional or polyfunctional, and examples thereof include compounds represented by the following Formula (III):

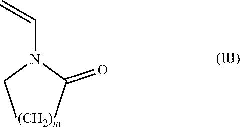

wherein m represents an integer of 1 to 5.

From the viewpoint of being easy to obtain raw materials, m is preferably an integer of 2 to 4, and more preferably 2 or 4. Examples of such N-vinyllactams include specifically N-vinylpyrrolidone and N-vinylcaprolactam.

From the viewpoint of being easy to enhance the strength and hardness of a resulting model material, the model material color composition preferably comprises, as the nitrogen atom-containing ethylenically unsaturated monomer (B2), at least one selected from the group consisting of (meth)acrylamides and N-vinyllactams, more preferably comprises a (meth)acrylamide, and even more preferably comprises a (meth)acrylamide in which Q³ in Formula (II) has 4 to 20 carbon atoms and constitutes an alicyclic group, and particularly preferably comprises acryloylmorpholine.

The content of the nitrogen atom-containing ethylenically unsaturated monomer (B2) contained in the model material color composition is preferably 10% by mass or more, more preferably 15% by mass or more, and even more preferably 20% by mass or more, and is preferably 50% by mass or less, more preferably 45% by mass or less, and even more preferably 40% by mass or less based on the total mass of the model material color composition. When the content of the nitrogen atom-containing ethylenically unsaturated monomer (B2) is equal to or more than the above-mentioned lower limit, it is easy to impart high strength and hardness to a resulting model material, and the dimensional stability of the model material is easily improved. When the content of the nitrogen atom-containing ethylenically unsaturated monomer (B2) is equal to or less than the above-mentioned upper limit, the viscosity of the model material color composition is easily controlled, and good jettability through a nozzle is easily secured.

The model material color composition contained in the model material composition set of the present invention preferably comprises, as the ethylenically unsaturated monomer (B), a monofunctional ethylenically unsaturated monomer and a di- or more functional ethylenically unsaturated monomer. Examples of the monofunctional ethylenically unsaturated monomer include the monofunctional (meth)acrylates and the monofunctional nitrogen atom-containing ethylenically unsaturated monomers mentioned above. Examples of the di- or more functional ethylenically unsaturated monomers include the polyfunctional (meth)acrylates and the polyfunctional nitrogen atom-containing ethylenically unsaturated monomers mentioned above. When the model material color composition contained in the model material composition set of the present invention comprises a di- or more functional ethylenically unsaturated monomer in addition to the monofunctional ethylenically unsaturated monomer, a resulting model material tends to have improved toughness and strength.

The content of the monofunctional ethylenically unsaturated monomer in the model material color composition is preferably 30% by mass or more, more preferably 35% by mass or more, and even more preferably 40% by mass or more, and is preferably 70% by mass or less, and more preferably 65% by mass or less based on the total mass of the model material color composition. When the content of the monofunctional ethylenically unsaturated monomer in the model material color composition is equal to or more than the above-mentioned lower limit, it is easy to reduce the viscosity of the model material color composition and enhance the jettability. When the content of the monofunctional ethylenically unsaturated monomer is equal to or less than the above-mentioned upper limit, a resulting model material tends to have an enhanced strength and hardness, and the stickiness of a surface of the model material tends to be suppressed.

The content of the di- or more functional ethylenically unsaturated monomer in the model material color composition is preferably 5% by mass or more, more preferably 8% by mass or more, and even more preferably 10% by mass or more, and is preferably 50% by mass or less, more preferably 40% by mass or less, and even more preferably 35% by mass or less based on the total mass of the model material color composition. When the content of the di- or more functional ethylenically unsaturated monomer in the model material color composition is equal to or more than the above-mentioned lower limit, a resulting model material tends to have an improved toughness, and well-balanced mechanical characteristics tend to be imparted to the model material. When the content of the di- or more functional ethylenically unsaturated monomer is equal to or less than the above-mentioned upper limit, curing shrinkage during photocuring of the model material color composition tends to be suppressed, and a resulting model material tends to have an improved dimensional accuracy (or warpage prevention property).

In one preferred embodiment of the present invention, the model material color composition preferably comprises the above-mentioned monofunctional (meth)acrylate having an aliphatic cyclic structure, the polyfunctional (meth)acrylate, and the monofunctional nitrogen atom-containing ethylenically unsaturated monomer. When a model material color composition comprises a monofunctional (meth)acrylate having an aliphatic cyclic structure and a polyfunctional (meth)acrylate, it is easy to reduce the viscosity of the composition and enhance the jettability, and at the same time, a resulting model material tends to have an improved toughness, and it is easy to impart well-balanced mechanical characteristics to the model material. Furthermore, when the model material color composition comprises a monofunctional nitrogen atom-containing ethylenically unsaturated monomer, a resulting model material tends to have an improved strength.

In this embodiment, from the viewpoint of being easy to obtain the above-described effects, the content of the monofunctional (meth)acrylate having an aliphatic cyclic structure in the model material color composition is preferably 5% by mass or more, and more preferably 10% by mass or more, and is preferably 75% by mass or less, and more preferably 60% by mass or less based on the total mass of the model material color composition. The content of the polyfunctional (meth)acrylate is preferably 5% by mass or more, and more preferably 10% by mass or more, and is preferably 50% by mass or less, and more preferably 45% by mass or less, based on the total mass of the model material color composition. Furthermore, the content of the monofunctional nitrogen atom-containing ethylenically unsaturated monomer is preferably 5% by mass or more, and more preferably 10% by mass or more, and is preferably 50% by mass or less, and more preferably 40% by mass or less.

The model material color composition contained in the model material composition set of the present invention preferably further comprises a polymerizable oligomer. When the model material color composition contains a polymerizable oligomer, the toughness of a model material tends to be improved, and a well-balanced mechanical strength can be secured, so that a model material that is hardly broken even when bent is obtained. In addition, it becomes easy to reduce the tackiness of the surface of the model material.

Examples of the polymerizable oligomer include an epoxy (meth)acrylate oligomer, a polyester (meth)acrylate oligomer, and a urethane (meth)acrylate oligomer. These may be used singly or two or more thereof may be used in combination. From the viewpoint of being capable of imparting strength and toughness to a resulting model material, offering a wide range of material selection, and allowing selection of a material having various characteristics, the polymerizable oligomer to be suitably used is preferably a polymerizable oligomer having a urethane group, and more preferably a urethane (meth)acrylate oligomer.

From the viewpoint of being easy to design the model material color composition to have a low viscosity, being easy to enhance the hardness and strength of a resulting model material, and being easy to reduce the cure shrinkage, the polymerizable oligomer having a urethane group is preferably a caprolactone-modified polymerizable oligomer. When the model material color composition comprises a polymerizable oligomer, the polymerizable oligomer is preferably a caprolactone-modified, isophorone diisocyanate-based polymerizable oligomer from the viewpoint of being easy to enhance the hardness and strength of a resulting model material.

When the model material color composition contains a polymerizable oligomer, the content thereof is preferably 10% by mass or more, and more preferably 15% by mass or more, and preferably 45% by mass or less, and more preferably 30% by mass or less based on the total mass of the model material color composition. When the content of the polymerizable oligomer is equal to or more than the above-mentioned lower limit, the tackiness of a surface of a model material may be sufficiently reduced. When the content of the polymerizable oligomer is equal to or less than the above-mentioned upper limit, a good jettability of the model material color composition is easily secured.

The model material color composition may comprise, as necessary, other additives unless the effects of the present invention are impaired. Examples of the other additives include photopolymerization initiators, surface conditioners, storage stabilizers, antioxidants, coloring agents, ultraviolet absorbing agents, light stabilizers, polymerization inhibitors, chain transfer agents, and fillers. These components are not particularly limited, and known compounds conventionally used in the art can be appropriately selected and used. As the photopolymerization initiator and the storage stabilizer, the same photopolymerization initiator and storage stabilizer as those described above as examples of the photopolymerization initiator and the storage stabilizer that may be contained in the model material clear composition can be suitably used also in the model material color composition in the same amounts. The additive contained in the model material clear composition and the additive contained in the model material color composition may be the same or different from each other.

Examples of the surface conditioner that may be contained in the model material color composition include the same agents as those described above as examples of the surface conditioner that may be contained in the model material clear composition. When the model material color composition comprises a surface conditioner, the content thereof is preferably 0.005% by mass or more, more preferably 0.01% by mass or more, and even more preferably 0.05% by mass or more, and is preferably 2% by mass or less, more preferably 1.5% by mass or less, and even more preferably 1% by mass or less based on the total mass of the model material color composition. When the content of the surface conditioner is within the above range, the surface tension of the model material color composition is easily controlled to an appropriate range.

Each of the model material clear composition and the model material color composition, which makes up the model material composition set of the present invention, preferably comprises a surface conditioner. In this case, the amount of the surface conditioner contained in the model material color composition (i.e., the content (% by mass) of the surface conditioner based on the total mass of the model material color composition) is preferably smaller than the amount of the surface conditioner contained in the model material clear composition (the content (% by mass) of the surface conditioner based on the total mass of the model material clear composition). When the amount of the surface conditioner contained in the model material color composition is smaller than the amount of the surface conditioner contained in the model material clear composition, repelling between the model material clear composition and the model material color composition at the interface is suppressed. As a result, a clear boundary between the clear model material and the color model material is formed in a resulting model material, so that a model material superior in appearance can be obtained. In this case, the amount of the surface conditioner contained in the model material color composition may be appropriately determined according to the types and proportions of the polymerizable compounds which make up the model material color composition and the model material clear composition. In one embodiment of the present invention, the amount (% by mass) of the surface conditioner contained in the model material color composition is preferably 30% or more, more preferably 35% or more, and even more preferably 40% or more, and is preferably 85% or less, more preferably 70% or less, and even more preferably 60% or less based on the amount (% by mass) of the surface conditioner contained in the model material clear composition of the present invention.

The model material color composition in the model material composition set of the present invention is usually a colored composition containing a pigment. Although the constitution of the model material color composition is not particularly limited, the model material color composition preferably contains cyan, magenta and yellow, and more preferably further contains white and/or black.

From the viewpoint of color tone and color development as well as ease of pigment dispersion, cyan preferably contains at least one pigment selected from the group consisting of C.I. Pigment Blue 15:3 and C.I. Pigment Blue 15:4.

From the viewpoint of color tone and color development as well as ease of pigment dispersion, magenta preferably contains at least one pigment selected from the group consisting of C.I. Pigment Red 122, C.I. Pigment Red 202, and C.I. Pigment Violet 19.

From the viewpoint of color tone and color development as well as ease of pigment dispersion, yellow preferably contains at least one pigment selected from the group consisting of C.I. Pigment Yellow 150 and C.I. Pigment Yellow 155.

From the viewpoint of color tone and concealability as well as ease of pigment dispersion, white preferably contains titanium oxide. From the viewpoint of being easy to improve the light stability of the ink, titanium oxide is more preferably rutile type titanium oxide.

From the viewpoint of color tone and color development as well as ease of pigment dispersion, black preferably contains carbon black.

The content of the pigment in the model material color composition may be appropriately determined according to the desired color tone of the model material color composition and the type of the pigment to be used, but is usually 0.1% by mass or more, and more preferably 0.2% by mass or more based on the total mass of the model material color composition. The upper limit of the content of the pigment in the model material color composition also is not particularly limited, and it is usually 5% by mass or less, and preferably 3% by mass or less based on the total amount of the model material color composition.

The viscosity of the model material color composition is preferably 1 mPa·s or more and less than 500 mPa·s at 25° C. for use in a material-jet optical shaping process. The viscosity at 25° C. is preferably 10 to 400 mPa·s, and more preferably 20 to 300 mPa·s from the viewpoint of improving jettability from a material jetting nozzle. The viscosity can be measured using a R100 type viscometer in accordance with JIS Z 8803. The viscosity of the model material color composition can be controlled by adjusting the type and blending ratio of a polymerizable compound, and the type and addition amount of a dilution solvent and a thickener.

The surface tension of the model material color composition of the present invention is preferably from 24 to 34 mN/m, and more preferably from 28 to 30 mN/m. When the surface tension is within the above range, the droplet jetted through a nozzle can be normally formed even at the time of high-speed jetting in material jet, an appropriate droplet amount is easily secured, and it becomes easy to improve the shaping accuracy. In the present invention, the surface tension of the model material color composition can be controlled by adjusting the type and blending amount of the surface conditioner.

In the present invention, the method for producing the model material color composition is not particularly limited, and for example, the model material color composition can be produced by uniformly mixing components which make up the model material color composition using a mixing and stirring device.

### Composition Set for Material-Jet Optical Shaping

In order to form a complicated shape or a minute shape with high accuracy, the model material clear composition and/or the model material composition set of the present invention is preferably used in combination with a support material for supporting the model material during three-dimensional shaping. Accordingly, the present invention is also directed to a composition set for material-jet optical shaping comprising the model material clear composition of the present invention or the model material composition set of the present invention and a support material composition for shaping a support material by a material-jet optical shaping process.

### Support Material Composition

The support material composition is a photocurable resin composition for a support material which affords a support material by photocuring. After the model material is produced, the support material can be removed from the model material by physical peeling or dissolving the support material in an organic solvent or water. The model material clear composition and the model material composition set of the present invention can be used in combination with various compositions conventionally known as support material compositions. The support material composition constituting the composition set for optical shaping of the present invention is preferably soluble in water because the model material is not damaged when the support material is removed, the support material is environmentally friendly, and the support material can be removed cleanly and easily even in a fine part.

Examples of such a water-soluble support material composition include those containing a monofunctional ethylenically unsaturated monomer and a polyalkylene glycol having an oxyethylene group and/or an oxypropylene group.

The monofunctional ethylenically unsaturated monomer contained in the support material composition is a polymerizable monomer having one ethylenic double bond in the molecule and having a property of being cured by energy rays, and is preferably a water-soluble monofunctional ethylenically unsaturated monomer. Examples of the monofunctional ethylenically unsaturated monomer contained in the support material composition include hydroxy group-containing (meth)acrylates having 2 to 15 carbon atoms [e.g., hydroxyethyl (meth)acrylate, hydroxypropyl (meth)acrylate, and 4-hydroxybutyl (meth)acrylate], hydroxy group-containing (meth)acrylates having a number average molecular weight (Mn) of 200 to 1,000 [e.g., polyethylene glycol mono(meth)acrylate, monoalkoxy(1 to 4 carbon atoms)polyethylene glycol mono(meth)acrylate, polypropylene glycol mono(meth)acrylate, monoalkoxy(1 to 4 carbon atoms)polypropylene glycol mono(meth)acrylate, and mono(meth)acrylate of PEG-PPG block polymer], (meth)acrylamide derivatives having 3 to 15 carbon atoms [e.g., (meth)acrylamide, N-methyl(meth)acrylamide, N-ethyl(meth)acrylamide, N-propyl(meth)acrylamide, N-butyl(meth)acrylamide, N,N′-dimethyl(meth)acrylamide, N,N′-diethyl(meth)acrylamide, N-hydroxyethyl(meth)acrylamide, N-hydroxypropyl(meth)acrylamide, and N-hydroxybutyl(meth)acrylamide], and (meth)acryloylmorpholine. These may be used singly or two or more thereof may be used in combination.

From the viewpoint of improving the curability of the support material composition, and easily and rapidly dissolving in water the support material obtained by photocuring the support material composition, the content of the monofunctional ethylenically unsaturated monomer contained in the support material composition is preferably 20% by mass or more, and more preferably 25% by mass or more based on the total amount of the support material composition. The content is preferably 50% by mass or less, and more preferably 45% by mass or less.

The support material composition preferably comprises a polyalkylene glycol containing an oxyethylene group and/or an oxypropylene group. The polyalkylene glycol containing an oxyethylene group and/or an oxypropylene group is such that at least ethylene oxide and/or propylene oxide is added to an active hydrogen compound. Examples of the polyalkylene glycol include polyethylene glycol and polypropylene glycol. These may be used singly or two or more thereof may be used in combination. Examples of the active hydrogen compound include monohydric to tetrahydric alcohols and amine compounds. Among them, a dihydric alcohol or water is preferable.

From the viewpoint of being easy to enhance the solubility in water of the support material obtained by photocuring the support material composition, the content of the polyalkylene glycol in the support material composition is preferably 20% by mass or more, and more preferably 25% by mass or more based on the total amount of the support material composition. In addition, from the viewpoint of preventing the phenomenon that the polyalkylene glycol leaks out of the support material during molding a three-dimensionally shaped article and easily enhancing the preciseness of molding, the content is preferably 49% by mass or less, and more preferably 45% by mass or less.

The number average molecular weight (Mₙ) of the polyalkylene glycol is preferably from 100 to 5,000. When the (Mₙ) of the polyalkylene glycol is within the above-mentioned range, the polyalkylene glycol is compatible with the polyalkylene glycol before photocuring and is incompatible with the polyalkylene glycol after photocuring. As a result, the self-standing ability of the support material obtained by photocuring the support material composition can be improved, and the solubility of the support material in water can be improved. The (Mₙ) of the polyalkylene glycol is preferably from 200 to 3,000, and more preferably from 400 to 2,000.

The support material composition may contain other additives, if necessary. Examples of the other additives include photopolymerization initiators, water-soluble organic solvents, antioxidants, coloring agents, pigment dispersants, storage stabilizers, ultraviolet absorbing agents, light stabilizers, polymerization inhibitors, chain transfer agents, and fillers.

As the photopolymerization initiator, the compounds described above as examples of the photopolymerization initiator that may be contained in the model material clear composition can be similarly used. When the support material composition contains a photopolymerization initiator, the content thereof is preferably 2% by mass or more, and more preferably 3% by mass or more, and is preferably 20% by mass or less, and more preferably 10% by mass or less, based on the total amount of the support material composition. When the content of the photopolymerization initiator is within the above-mentioned range, it is easy to reduce unreacted polymerizable components and sufficiently enhance the curability of the support material.

The water-soluble organic solvent is a component that improves the solubility in water of the support material obtained by photocuring the support material composition. Moreover, it is also a component that can adjust the support material composition to have a low viscosity. When the support material composition contains a water-soluble organic solvent, the content of the water-soluble organic solvent is preferably 35% by mass or less, and more preferably 30% by mass or less based on the total amount of the support material composition. The content is preferably 3% by mass or more, more preferably 5% by mass or more, and even more preferably 10% by mass or more. When the amount of the water-soluble organic solvent in the support material composition is excessively large, effusion of the water-soluble organic solvent occurs when the support material composition is photocured, so that the dimensional accuracy of the model material formed on the upper layer of the support material may deteriorate. When the content of the water-soluble organic solvent is equal to or less than the above-mentioned upper limit, such effusion tends to be suppressed. In addition, when the content of the water-soluble organic solvent in the support material composition is equal to or more than the above-mentioned lower limit, it is easy to improve the removability of the support material by water and it is also easy to control the support material composition to have a low viscosity.

Examples of the water-soluble organic solvent include alkylene glycol monoacetates having a linear or branched alkylene group [e.g., ethylene glycol monoacetate, propylene glycol monoacetate, diethylene glycol monoacetate, dipropylene glycol monoacetate, triethylene glycol monoacetate, tripropylene glycol monoacetate, tetraethylene glycol monoacetate, and tetrapropylene glycol monoacetate], alkylene glycol monoalkyl ethers having a linear or branched alkylene group [e.g., ethylene glycol monomethyl ether, propylene glycol monomethyl ether, diethylene glycol monomethyl ether, dipropylene glycol monomethyl ether, triethylene glycol monomethyl ether, tripropylene glycol monomethyl ether, tetraethylene glycol monomethyl ether, tetrapropylene glycol monomethyl ether, ethylene glycol monoethyl ether, propylene glycol monoethyl ether, diethylene glycol monoethyl ether, dipropylene glycol monoethyl ether, triethylene glycol monoethyl ether, tripropylene glycol monoethyl ether, tetraethylene glycol monoethyl ether, tetrapropylene glycol monoethyl ether, ethylene glycol monopropyl ether, propylene glycol monopropyl ether, diethylene glycol monopropyl ether, dipropylene glycol monopropyl ether, triethylene glycol monopropyl ether, tripropylene glycol monopropyl ether, tetraethylene glycol monopropyl ether, tetrapropylene glycol monopropyl ether, ethylene glycol monobutyl ether, propylene glycol monobutyl ether, diethylene glycol monobutyl ether, dipropylene glycol monobutyl ether, triethylene glycol monobutyl ether, tripropylene glycol monobutyl ether, tetraethylene glycol monobutyl ether, and tetrapropylene glycol monobutyl ether], alkylene glycol diacetates having a linear or branched alkylene group [e.g., ethylene glycol diacetate, propylene glycol diacetate, diethylene glycol diacetate, dipropylene glycol diacetate, triethylene glycol diacetate, tripropylene glycol diacetate, tetraethylene glycol diacetate, and tetrapropylene glycol diacetate], alkylene glycol dialkyl ethers having a linear or branched alkylene group [e.g., ethylene glycol dimethyl ether, propylene glycol dimethyl ether, diethylene glycol dimethyl ether, dipropylene glycol dimethyl ether, triethylene glycol dimethyl ether, tripropylene glycol dimethyl ether, tetraethylene glycol dimethyl ether, tetrapropylene glycol dimethyl ether, ethylene glycol diethyl ether, propylene glycol diethyl ether, diethylene glycol diethyl ether, dipropylene glycol diethyl ether, triethylene glycol diethyl ether, tripropylene glycol diethyl ether, tetraethylene glycol diethyl ether, tetrapropylene glycol diethyl ether, ethylene glycol dipropyl ether, propylene glycol dipropyl ether, diethylene glycol dipropyl ether, dipropylene glycol dipropyl ether, triethylene glycol dipropyl ether, tripropylene glycol dipropyl ether, tetraethylene glycol dipropyl ether, tetrapropylene glycol dipropyl ether, ethylene glycol dibutyl ether, propylene glycol dibutyl ether, diethylene glycol dibutyl ether, dipropylene glycol dibutyl ether, triethylene glycol dibutyl ether, tripropylene glycol dibutyl ether, tetraethylene glycol dibutyl ether, and tetrapropylene glycol dibutyl ether], alkylene glycol monoalkyl ether acetates having a linear or branched alkylene group [e.g., ethylene glycol monomethyl ether acetate, propylene glycol monomethyl ether acetate, diethylene glycol monomethyl ether acetate, dipropylene glycol monomethyl ether acetate, triethylene glycol monomethyl ether acetate, tripropylene glycol monomethyl ether acetate, tetraethylene glycol monomethyl ether acetate, tetrapropylene glycol monomethyl ether acetate, ethylene glycol monoethyl ether acetate, propylene glycol monoethyl ether acetate, diethylene glycol monoethyl ether acetate, dipropylene glycol monoethyl ether acetate, triethylene glycol monoethyl ether acetate, tripropylene glycol monoethyl ether acetate, tetraethylene glycol monoethyl ether acetate, tetrapropylene glycol monoethyl ether acetate, ethylene glycol monopropyl ether acetate, propylene glycol monopropyl ether acetate, diethylene glycol monopropyl ether acetate, dipropylene glycol monopropyl ether acetate, triethylene glycol monopropyl ether acetate, tripropylene glycol monopropyl ether acetate, tetraethylene glycol monopropyl ether acetate, tetrapropylene glycol monopropyl ether acetate, ethylene glycol monobutyl ether acetate, propylene glycol monobutyl ether acetate, diethylene glycol monobutyl ether acetate, dipropylene glycol monobutyl ether acetate, triethylene glycol monobutyl ether acetate, tripropylene glycol monobutyl ether acetate, tetraethylene glycol monobutyl ether acetate, and tetrapropylene glycol monobutyl ether acetate]. These may be used singly or two or more thereof may be used in combination. Among them, the water-soluble organic solvent is more preferably triethylene glycol monomethyl ether or dipropylene glycol monomethyl ether acetate from the viewpoint of being easy to improve the removability of the support material by water and easy to control the support material composition to have a low viscosity.

The viscosity of the support material composition in the present invention is preferably 1 to 500 mPa·s, and more preferably 10 to 400 mPa·s at 25° C. from the viewpoint of improving jettability from a material jetting nozzle. The viscosity can be measured using a R100 type viscometer in accordance with JIS Z 8803.

In the present invention, the method for producing the support material composition is not particularly limited, and for example, the support material composition can be produced by uniformly mixing components which make up the support material composition using a mixing and stirring device.

### Method for Producing Optically Shaped Article

Using the model material clear composition, the model material composition set, or the composition set for material-jet optical shaping of the present invention, a three-dimensionally shaped article (a model material) can be produced by an optical shaping process by a material-jet system.

The method for producing an optically shaped article is not particularly limited as long as it is a method of producing a three-dimensionally shaped article by an optical shaping process by a material-jet system using the model material clear composition, the model material composition set, or the composition set for optical shaping of the present invention, and a known method can be employed. A model material, which is a three-dimensionally shaped article, can be obtained, for example, by a method comprising a step of photocuring the model material clear composition (and the model material color composition) to obtain a model material and photocuring the support material composition to obtain a support material, and a step of removing the support material from the model material.

In the production method, for example, the optically shaped article may be produced as follows: based on three-dimensional CAD data of an article to be produced, data of a model material clear composition (and a model material color composition) that is laminated by a material-jet method to constitute a three-dimensionally shaped article and data of a support material composition that supports the three-dimensionally shaped article under fabrication are prepared, then slice data for jetting each composition with a material-jet 3D printer is further prepared, and after each of the composition for a model material and the composition for a support material is discharged based on the prepared slice data, photocuring treatment is repeated for each layer, and thus an optically shaped article composed of a cured product (a model material) of the model material clear composition (and the model material color composition) and a cured product of the support material composition (a support material) can be produced.

Examples of the light that cures the model material clear composition (and the model material color composition) and the support material composition include active energy rays such as far infrared rays, infrared rays, visible rays, near ultraviolet rays, ultraviolet rays, electron beams, α-rays, γ-rays, and X-rays. Among these, near ultraviolet rays or ultraviolet rays are preferable from the viewpoint of easiness and efficiency of curing work.

Examples of a light source include conventionally publicly-known high-pressure mercury lamps, metal halide lamps, and UV-LEDs. Among these, an LED system is preferable from the viewpoint of being capable of reducing the size of facility and requiring small power consumption. The light quantity is preferably 200 to 500 mJ/cm² from the viewpoint of the hardness and dimensional accuracy of a model material. When a UV-LED is used as a light source, it is preferable to use a light source having a center wavelength of 385 to 415 nm because light easily reaches a deep layer and the hardness and dimensional accuracy of the resulting model material can be improved.

The thickness of each layer constituting the three-dimensionally shaped article is preferably thinner from the viewpoint of shaping accuracy, but is preferably from 5 to 30 µm from the balance with the shaping speed.

The resulting three-dimensionally shaped article is a combination of the model material and the support material. By removing the support material from the three-dimensionally shaped article, a three-dimensionally shaped article, which is the model material, can be obtained. The removal of the support material is preferably performed as follows: for example, the resulting three-dimensionally shaped article is immersed in a removal solvent capable of dissolving the support material, thereby softening the support material, and then the support material is removed with a brush or the like from the surface of the model material. As the solvent for removing the support material, water, a water-soluble solvent such as a glycol-based solvent or an alcohol-based solvent may be used. These may be used singly or two or more thereof may be used in combination.

Through the steps described above, a three-dimensionally shaped article made of a model material is obtained. The three-dimensionally shaped article produced by using such a model material clear composition, model material composition set, or composition set for optical shaping of the present invention has high transparency with suppressed color change (yellowing) due to photoirradiation and has well-balanced mechanical characteristics.

### EXAMPLES

Hereinafter, the present invention will be described in more detail by way of Examples. In Examples, “%” and “part” are “% by mass” and “part by mass”, respectively, unless otherwise specified.

### 1. Model Material Clear Composition

The details of the components constituting the model material clear compositions used in Examples and Comparative Examples are shown in Table 1.

TABLE 1

| | | | | | |
|---|---|---|---|---|---|
| | | | Abbreviation | Name of component | Specification |
| Polymerizable compound | Ethylenically unsaturated compound (A) | Ethylenically unsaturated monomer (A1) | FA-511AS | Dicyclopentenyl acrylate | FANCRYL FA-511AS manufactured by Hitachi Chemical Co., Ltd. (ethylenic double bond(s)/molecule: 1 bond) |
| | | | FA-512AS | Dicyclopentenyloxyethyl acrylate | FANCRYL FA-512AS manufactured by Hitachi Chemical Co., Ltd. (ethylenic double bond(s)/molecule: 1 bond) |
| | | | FA-512M | Dicyclopentenyloxyethyl methacrylate | FANCRYL FA-512M manufactured by Hitachi Chemical Co., Ltd. (ethylenic double bond(s)/molecule: 1 bond) |
| | | | FA-513AS | Dicyclopentanyl acrylate | FANCRYL FA-513AS manufactured by Hitachi Chemical Co., Ltd. (ethylenic double bond(s)/molecule: 1 bond) |
| | | Ethylenically unsaturated compound (A2) | N-981 | Urethane-based polymerizable oligomer component having isophorone structure | SARTOMER CN-981 manufactured by Arkema S.A. (ethylenic double bond(s)/molecule: 2 bonds) |
| | | | CN-991 | Urethane-based polymerizable oligomer component having dicyclohexylmethane structure | SARTOMER CN-991 manufactured by Arkema S.A. (ethylenic double bond(s)/molecule: 2 bonds) |
| | | | Ebe8402 | Urethane-based polymerizable oligomer component having dicyclohexylmethane structure | Ebecryl 8402 manufactured by Daicel-Allnex Ltd. (ethylenic double bond(s)/molecule: 2 bonds) |
| | | Ethylenically unsaturated monomer (A3) | CHA | Cyclohexyl acrylate | Viscoat#155 manufactured by Osaka Organic Chemical Industry Ltd. (ethylenic double bond(s)/molecule: 1 bond) |
| | | | TBCHA | 4-t-Butylcyclohexyl acrylate | SARTOMER SR-420 manufactured by Arkema S.A. (ethylenic double bond(s)/molecule: 1 bond) |
| | | | TMCHA | 3,5,5-Trimethylcyclohexyl acrylate | SARTOMER SR217 manufactured by Arkema S.A. (ethylenic double bond(s)/molecule: 1 bond) |
| | | | IBOA | Isobornyl acrylate | SARTOMER SR506D manufactured by Arkema S.A. (ethylenic double bond(s)/molecule: 1 bond) |
| | | | TCDA | Tricyclodecanedimethanol diacrylate | SARTOMER CD406 manufactured by Arkema S.A. (ethylenic double bond(s)/molecule: 2 bonds) |
| | | | CHDMMA | 1,4-Cyclohexanedimethanol diacrylate | SARTOMER SR833 manufactured by Arkema S.A. (ethylenic double bond(s)/molecule: 2 bonds) |
| | | Ethylenically unsaturated compound (A4) | ACMO | Acryloylmorpholine | Acryloylmorpholine manufactured by KJ Chemicals Corporation (ethylenic double bond(s)/molecule: 1 bond) |
| | | | NVC | N-Vinylcaprolactam | V-Cap RC manufactured by ASHLAND Inc. (ethylenic double bond(s)/molecule: 1 bond) |
| | | | HDDA | Hexanediol diacrylate | SARTOMER SR238 manufactured by Arkema S.A. (acrylic group(s)/molecule: 2 groups) |
| | | | TPGDA | Tripropylene glycol diacrylate | SARTOMER SR306 manufactured by Arkema S.A. (acrylic qroup(s)/molecule: 2 groups) |
| | | | CTFA | Cyclic trimethylolpropane formal acrylate | Viscoat#200 manufactured by Osaka Organic Chemical Industry Ltd. (ethylenic double bond(s)/molecule: 1 bond) |
| | | | PEA | Phenoxyethyl acrylate | SARTOMER SR339NS manufactured by Arkema S.A. (ethylenic double bond(s)/molecule: 1 bond) |
| Photopolymerization initiator | Acylphosphine oxide-based | | DAROCURE TPO | 2,4,6-Trimethylbenzoyl-diphenyl-phosphine oxide | DAROCURE TPO manufactured by BASF SE |
| Surface conditioner | Silicone-based | | BYK-UV3500 | Silicone-based surface conditioner having polydimethylsiloxane structure | BYK-UV3500 manufactured by BYK-Chemie GmbH |
| Storage stabilizer | | | HYDROXY-TEMPO | 4-Hydroxy-2,2,6,6-tetramethylpiperidine-N-oxyl | H-TEMPO manufactured by Evonik Degussa Japan Co., Ltd. |

### Preparation of Model Material Clear Composition

According to each composition shown in Table 2, the components constituting each model material clear composition were uniformly mixed and stirred using a mixing and stirring device to prepare each model material clear composition of Examples 1 to 16 and Comparative Examples 1 to 5.

TABLE 2

| | | | Abbreviation | Example | | | | | | | | | | | | | | | | Comparative Example | | | | |
|---|---|---|---|---|---|---|---|---|---|---|---|---|---|---|---|---|---|---|---|---|---|---|---|---|
| | | | | 1 | 2 | 3 | 4 | 5 | 6 | 7 | 8 | 9 | 10 | 11 | 12 | 13 | 14 | 15 | 16 | 1 | 2 | 3 | 4 | 5 |
| Polymerizable compound | Ethylenically unsaturated compound (A) | Ethylenically unsaturated monomer (A1) | FA-511AS | 50.0 | - | - | - | - | - | - | - | - | - | - | - | - | - | - | - | - | 50.0 | 50.0 | 50.0 | - |
| | | | FA-512AS | - | 50.0 | - | - | 50.0 | 50.0 | 50.0 | 50.0 | 50.0 | - | - | 50.0 | - | - | 77.0 | 50.0 | - | - | - | - | - |
| | | | FA-512M | - | - | 50.0 | - | - | - | - | - | - | - | - | - | - | - | - | - | - | - | - | - | - |
| | | | FA-513AS | - | - | - | 50.0 | - | - | - | - | - | 50.0 | 50.0 | - | 40.0 | 30.0 | - | - | 25.0 | - | - | - | - |
| | | Ethylenically unsaturated compound (A2) | CN-981 | - | - | - | - | - | - | - | - | - | 22.0 | - | - | - | - | 10.0 | - | 18.0 | - | - | - | - |
| | | | CN-991 | - | - | - | - | 22.0 | 22.0 | 22.0 | 22.0 | 22.0 | - | 22.0 | - | 22.0 | 22.0 | - | - | - | 22.0 | 22.0 | - | - |
| | | | Ebe5402 | 22.0 | 22.0 | 22.0 | 22.0 | - | - | - | - | - | - | - | 22.0 | - | - | - | 22.0 | - | - | - | - | 25.0 |
| | | Ethylenically unsaturated monomer (A3) | CHA | - | - | - | - | 24.7 | - | - | - | - | - | - | - | - | - | - | - | - | - | - | - | - |
| | | | TBCHA | - | - | - | - | - | 24.7 | - | - | - | - | - | - | - | - | - | - | - | - | - | - | - |
| | | | TMCHA | - | - | - | - | - | - | 24.7 | - | - | 24.7 | 24.7 | - | 20.7 | 9.7 | - | - | 10.7 | - | - | 20.7 | - |
| | | | TBOA | 24.7 | 24.7 | 24.7 | 24.7 | - | - | - | - | - | - | - | 24.8 | - | - | 9.7 | 14.7 | - | - | - | - | 30.0 |
| | | | TCDA | - | - | - | - | - | - | - | 24.7 | - | - | - | - | - | - | - | - | - | - | - | - | - |
| | | | CHDMMA | - | - | - | - | - | - | - | - | 24.7 | - | - | - | - | - | - | - | - | - | - | - | - |
| | | Ethylenically unsaturated compound (A4) | ACMO | - | - | - | - | - | - | - | - | - | - | - | - | - | - | - | 10.0 | - | 24.7 | - | - | - |
| | | | NVC | - | - | - | - | - | - | - | - | - | - | - | - | - | - | - | - | - | - | 24.7 | - | - |
| | | | HDDA | - | - | - | - | - | - | - | - | - | - | - | - | - | - | - | - | - | - | - | - | 11.7 |
| | | | TPGDA | - | - | - | - | - | - | - | - | - | - | - | - | 14.0 | - | - | - | 43.0 | - | - | 26.0 | - |
| | | | CTFA | - | - | - | - | - | - | - | - | - | - | - | - | - | 35.0 | - | - | - | - | - | - | - |
| | | | PEA | - | - | - | - | - | - | - | - | - | - | - | - | - | - | - | - | - | - | - | - | 30.0 |
| Photopolymerizaton initiator | Acylphosphine oxide-based | | DAROCURE TPO | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 | 3.0 |
| Surface conditioner | Silicone-based | | BYK-UV3500 | 0.2 | 0.2 | 0.2 | 0.2 | 0.2 | 0.2 | 0.2 | 0.2 | 0.2 | 0.2 | 0.2 | 0.1 | 0.2 | 0.2 | 0.2 | 0.2 | 0.2 | 0.2 | 0.2 | 0.2 | 0.2 |
| Storage stabilizer | | | HYDROXY-TEMPO | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Total | | | | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| Amount (% by mass) of ethylenically unsaturated compound (A) in composition | | | | 96.7 | 96.7 | 96.7 | 96.7 | 96.7 | 96.7 | 96.7 | 96.7 | 96.7 | 96.7 | 96.7 | 96.8 | 96.7 | 96.7 | 96.7 | 96.7 | 96.7 | 96.7 | 96.7 | 96.7 | 96.7 |
| Amount (% by mass) of ethylenically unsaturated monomer having alipnaticcyclic structure in composition | | | | 96.7 | 96.7 | 96.7 | 96.7 | 96.7 | 96.7 | 96.7 | 96.7 | 96.7 | 96.7 | 96.7 | 96.8 | 82.7 | 61.7 | 96.7 | 86.7 | 53.7 | 72.0 | 72.0 | 70.7 | 55.0 |
| Proportion (%) of ethylenically unsaturated monomer having aliphatic cyclic structure in ethylenically unsaturated compound (A) | | | | 100 | 100 | 100 | 100 | 100 | 100 | 100 | 100 | 100 | 100 | 100 | 100 | 86 | 64 | 100 | 90 | 56 | 74 | 74 | 73 | 57 |

### Evaluation of Physical Properties and Characteristics of Cured Product of Model Material Clear Composition

Cured products (clear model materials) were produced from the model material clear compositions prepared in the above Examples and Comparative Examples, and the physical properties and characteristics of each cured product were evaluated in accordance with the following methods. The results are shown in Table 3.

### Measurement of Tensile Strength

Each of the model material clear compositions prepared in Examples and Comparative Examples, which was molded in accordance with the multipurpose specimen type A1 shape specified in JIS K 7139-2009 “Plastics -- Test specimens” using a molding apparatus in a ultraviolet ray-curing type inkjet system, was used as a sample to be measured, and tensile strength was measured in accordance with JIS K 7162:1994 “Plastics-Determination of tensile properties-Part 2: Test conditions for molding and extrusion plastics.” (molding conditions: lamination thickness per layer: 32 µm, illuminance: 1000 mW/cm², integrated light quantity per layer: 800 mJ/cm²) .

The measured tensile strength was evaluated according to the following evaluation criteria.

### Evaluation Criteria

O : tensile strength was 30 MPa or more.

Δ : tensile strength was 20 MPa or more and less than 30 MPa.

x : tensile strength was less than 20 MPa.

### Measurement of Shore D Hardness

An item composed of two samples shaped in accordance with a strip-shaped specimen shape B2 specified in JIS K 7139:2009 “Plastics -- Test specimens” with the same molding apparatus and under the same conditions as in the measurement of tensile strength and superposed in two layers was prepared as a measurement sample, and the Shore D hardness thereof was measured in accordance with JIS K 7215: 1986 “Testing method for durometer hardness of plastics”.

The measured Shore D hardness was evaluated according to the following evaluation criteria.

### Evaluation Criteria

O : Shore D hardness was 50 or more.

Δ : Shore D hardness was 30 or more and less than 50.

x : Shore D hardness was less than 30.

### Evaluation of Color Tone of Model Material

A Lab color difference was measured in accordance with the following procedure, and the color tone of a clear model material was evaluated.

Measurement of Lab color difference:

From each of the model material clear compositions prepared in Examples and Comparative Examples, a plate with 2 mm in thickness was molded using a molding apparatus in an ultraviolet ray-curing type inkjet system, and the plate was used as a sample to be measured (molding conditions: lamination thickness per layer: 32 µm, illuminance: 1000 mW/cm², integrated light quantity per layer: 800 mJ/cm²) . The Lab color difference of this sample was measured using a color difference meter “X-Rite 939” (manufactured by X-Rite).

Based on b* of the measured Lab color difference, the color tone of the model material was evaluated according to the following evaluation criteria.

### Evaluation Criteria

O : The value of b* was less than 5.

Δ : The value of b* was 5 or more and less than 10.

x : The value of b* was 10 or more.

TABLE 3

| | Example | | | | | | | | | | | | | | | | Comparative Example | | | | |
|---|---|---|---|---|---|---|---|---|---|---|---|---|---|---|---|---|---|---|---|---|---|
| Evaluation item | 1 | 2 | 3 | 4 | 5 | 6 | 7 | 8 | 9 | 10 | 11 | 12 | 13 | 14 | 15 | 16 | 1 | 2 | 3 | 4 | 5 |
| Color tone of clear model | O | O | O | O | O | O | O | O | O | O | O | O | Δ | Δ | O | Δ | x | x | x | O | x |
| Measurement of tensile strength | O | O | O | O | O | O | O | O | O | O | O | O | O | O | Δ | O | O | O | O | x | O |
| Measurement of Shore D | O | O | O | O | O | O | O | O | O | O | O | O | O | O | O | O | O | O | O | O | O |

It was confirmed that the model material clear composition according to the present invention had little yellowness and was superior in transparency, and had the strength and hardness of a prescribed level or more.

### 2. Model Material Composition Set

### Preparation of Model Material Color Composition

The details of the components constituting the model material color compositions used in Production Examples are shown in Table 4.

TABLE 4

| | | | | | | |
|---|---|---|---|---|---|---|
| | | | | Abbreviation | Name of component | Specification |
| Coloring agent | | | Black | MA-8 | Acidic carbon black pigment | MA-8 manufactured by Mitsubishi Chemical Corporation |
| | | | Yellow | 4G01 | Condensed 320 pigment | NOVOPERM YELLOW 4G01 (C.I. PY 155) manufactured by Clariant |
| | | | Magenta | RT355D | Quinacridone pigment | CINQUASIA Magenda RT-355-D (C.I.PR202 + C.I.PV 19) manufactured by Ciba |
| | | | Cyan | 84G | Copper phthalocyanine pigment | HOSTAPERM BLUE 84G (C.I. PB 15:3) manufactured by Clariant |
| | | | White | JR-806 | Titanium oxide (JR806) | JR806 manufactured by Tayca Corporation (Rutile type, alumina-silica surface-modified) |
| Pigment dispersant | | | | Sol.32000 | Comb-type copolymer having basic functional group | Sclsperse 32000 manufactured by Avecia Corporation |
| Polymerizable compound | Ethylenically unsaturated monomer (B) | Ethylenicaliy unsaturated monomer: (B1) | Monofunctional (meth)acrylate | IBOA | Isobornyl acrylate | SARTOMER SR5060 manufactured by Arkema S.A. (ethylenic double bond(s)/molecule. 1 bond) |
| | | | | TMCHA | 3,5,5-Trimethylcyclohexanol acrylate | SARTOMER SR420 manufactured by Arkama S.A. (ethylenic double bond(s)/molecule: 1 bond) |
| | | | Polyfunctional (meth)acrylate | HDDA | Hexanediol diacrylate | SARTOMER SR238 manufactured by Arkema S.A. ((meth)acrylic group(s)/molecule: 2 groups) |
| | | | | TPGDA | Tripropylene glycol diacrylate | SARTOMER SR306 manufactured by Arkema S.A. ((meth)acrylic group(s)/molecule: 2 groups) |
| | | Nitrogen -containing ethylenically unsaturated | | ACMO | Acryloylmorpholine | Acryloylmorpholine manufactured by KJ Chemicals Corporation (ethylenic double bond(s)/molecule: 1 bond) |
| | Polymerizable oligomer | | | CN-981 | Urethane-based polymerizable oligomer component having isophorone structure | SARTOMER CN-981 manufactured by Arkeme S.A. (ethylenic double bond(s)/molecule: 2 bonds) |
| Photopolymerization initiator | | Acylphosphine oxide-based | | DAROCURE TPO | 2,4,6-Trimethylbenzoyl-diphenylphosphine oxide | DAROCURE TPO manufactured by BASF SE |
| Surface conditioner | | Silicone-based | | TEGO-Red2100 | Silicone acrylate having polydimethylsiloxone structure | TEGO Rad 2100 manufactured by Degussa |
| Storage stabilizer | | | | HYDROXY-TEMPO | 4-Hydroxy-2,2,6,6-tetramethylpiperidine-N-oxyl | H-TEMPO manufactured by Evonik Degussa Japan Co., Ltd. |

According to each composition shown in Table 5, the components which make up each model material color composition were uniformly mixed and stirred using a mixing and stirring device to prepare each model material color composition of Production Examples 1 to 10.

### Evaluation of Physical Properties and Characteristics of Cured Product of Model Material Color Composition

Cured products (color model materials) were prepared from the model material color compositions prepared in the above Production Examples, and the tensile strength and Shore D hardness of each cured product were measured and evaluated by the same procedure and evaluation criteria as those for the measurement of the model material clear compositions of the above Examples. The results are shown in Table 5.

TABLE 5

| Component | | | | Abbreviation | Model material color composition | | | | | | | | | |
|---|---|---|---|---|---|---|---|---|---|---|---|---|---|---|
| | | | | | Production Example | | | | | | | | | |
| | | | | | 1 | 2 | 3 | 4 | 5 | 6 | 7 | 8 | 9 | 10 |
| Coloring agent | | | Black | MA-8 | 0.2 | - | - | - | - | 0.2 | - | - | - | - |
| | | | Yellow | Yellow 4G01 | - | 1.0 | - | - | - | - | 1.0 | - | - | - |
| | | | Magenta | RT355D | - | - | 1.0 | - | - | - | - | 1.0 | - | - |
| | | | Cyan | B4G | - | - | - | 0.2 | - | - | - | - | 0.2 | - |
| | | | White | JR-806 | - | - | - | - | 3.0 | - | - | - | - | 3.0 |
| Pigment dispersant | | | | Sol.32000 | 0.1 | 0.5 | 0.5 | 0.1 | 0.3 | 0.1 | 0.5 | 0.5 | 0.1 | 0.3 |
| Polymerizable compound | Ethylenically unsaturated monomer (B) | Nitrogen-containing ethylenically unsaturated monomer (B2) | | ACMO | 30 | 30 | 30 | 30 | 30 | - | - | - | - | - |
| | | Ethylenically unsaturated monomer (81) | Monofunctional (meth)acrylate | IBOA | 30 | 30 | 30 | 30 | 30 | 30 | 30 | 30 | 30 | 30 |
| | | | | TMCHA | - | - | - | - | - | 30 | 30 | 30 | 30 | 30 |
| | | | Polyfunctional (meth)acrylate | HDDA | - | - | - | - | - | 16.5 | 15.3 | 15.3 | 16.5 | 13.5 |
| | | | | TPGDA | 16.5 | 15.3 | 15.3 | 16.5 | 13.5 | - | - | - | - | - |
| | Polymerizable oligomer | | | CN-981 | 20 | 20 | 20 | 20 | 20 | 20 | 20 | 20 | 20 | 20 |
| Photopolymerization initiator | | Acylphosphine oxide-based | | DAROCURE TPO | 3 | 3 | 3 | 3 | 3 | 3 | 3 | 3 | 3 | 3 |
| Surface conditioner | | Silicone-based | | TEGO-Rad2100 | 0.1 | 0.1 | 0.1 | 0.1 | 0.1 | 0.1 | 0.1 | 0.1 | 0.1 | 0.1 |
| Storage stabilizer | | | | HYDROXY-TEMPO | 0.1 | 0.1 | 0.1 | 0.1 | 0.1 | 0.1 | 0.1 | 0.1 | 0.1 | 0.1 |
| Total | | | | | 100.0 | 100.0 | 100.0 | 100.0 | 100.0 | 100.0 | 100.0 | 100.0 | 100.0 | 100.0 |
| Physical properties of cured product of model material color composition | | | | | | | | | | | | | | |
| Color | | | | | K | Y | M | C | W | K | Y | M | C | W |
| Tensile strength | | | | | O | O | O | O | O | Δ | x | Δ | Δ | Δ |
| Shore D hardness | | | | | O | O | O | O | O | O | O | O | O | O |

### Evaluation of Model Material Composition Set

Bleeding at an interface between a model material clear composition and a model material color composition was evaluated in accordance with the following method using the model material clear compositions prepared in Examples 2 and 5 and the model material color compositions prepared in Production Examples 1 to 5.

### Method for Evaluating Bleeding

On a film made of polyethylene terephthalate (A4300, manufactured by Toyobo Co., Ltd., 100 mm × 150 mm × thickness 188 µm), a 0.02 mL droplet of the model material clear composition prepared in Example 2 and a 0.02 mL droplet of the model material color composition prepared in Production Example 1 were dropped using a micropipette such that the distance between the centers of the respective droplets was 5 mm and the droplets were independent from each other. Thereafter, the state of the interface between the droplets formed when the droplets gradually wet-spread and after about 10 seconds the droplets joined together was visually observed from above and bleeding was evaluated. In the same procedure as that described above, the bleeding was evaluated for combinations of the model material clear composition of Example 2 and each of the model material color compositions of Production Examples 2 to 10 and for combinations of the model material clear composition of Example 5 and each of the model material color compositions of Production Examples 1 to 10. As a result, it was confirmed that in all the combinations, the interface between the layer made of the model material clear composition and the layer made of the model material color composition was linear in top view and bleeding did not occur.

Further, bleeding was evaluated in the same procedure as that described above for combinations of the model material clear composition prepared in Example 12 and each of the model material color compositions prepared in Production Examples 1 to 10. As a result, in each of the combinations, slight bleeding was confirmed at the interface between the layer made of the model material clear composition and the layer made of the model material color composition.

1. A model material clear composition to be used in a material-jet optical shaping process, comprising an ethylenically unsaturated compound (A) and a photopolymerization initiator, wherein
the ethylenically unsaturated compound (A) comprises:
an ethylenically unsaturated monomer (A1) having a dicyclopentenyl group and/or a dicyclopentanyl group;
an ethylenically unsaturated compound (A2) having an aliphatic cyclic structure in a molecule and having a urethane group; and
an ethylenically unsaturated monomer (A3) having an aliphatic cyclic structure in a molecule and having neither a urethane group nor an amide group (excluding the ethylenically unsaturated monomer (A1)), and wherein
a total mass of the ethylenically unsaturated monomer (A1), the ethylenically unsaturated compound (A2), and the ethylenically unsaturated monomer (A3) is 60% by mass or more based on the total mass of the ethylenically unsaturated compound (A).

2. The model material clear composition according to claim 1, wherein the composition comprises the ethylenically unsaturated monomer (A1) in an amount of 30% by mass or more based on the total mass of the ethylenically unsaturated compound (A).

3. The model material clear composition according to claim 1, wherein the composition comprises an ethylenically unsaturated monomer having neither an aromatic group nor a vinyl ether group as well as neither a urethane group nor an amide group as the ethylenically unsaturated monomer (A3).

4. The model material clear composition according to claim 1, wherein the ethylenically unsaturated monomer (A3) has at least one group selected from the group consisting of a cyclohexyl group, a 4-t-butylcyclohexyl group, a 3,5,5-trimethylcyclohexyl group, an isobornyl group, a tricyclodecanyl group, a dicyclopentadienyl group and a 1,4-cyclohexanedimethanol group.

5. The model material clear composition according to claim 1 wherein the composition comprises the ethylenically unsaturated compound (A2) in an amount of 10% by mass or more based on the total mass of the ethylenically unsaturated compound (A).

6. The model material clear composition according to claim 1 , wherein the composition comprises an ethylenically unsaturated monomer having a nitrogen atom in the molecule and having no aliphatic cyclic structure in an amount of 12% by mass or less based on the total mass of the ethylenically unsaturated compound (A).

7. A model material composition set to be used in a material-jet optical shaping process, comprising the model material clear composition according to claim 1 and a model material color composition comprising an ethylenically unsaturated monomer (B).

8. The model material composition set according to claim 7, wherein the model material color composition comprises, based on a total mass of the model material color composition, 30 to 85% by mass of a (meth)acrylate-based ethylenically unsaturated monomer (B1), and 10 to 50% by mass of a nitrogen atom-containing ethylenically unsaturated monomer (B2) that is not a (meth)acrylate-based compound.

9. The model material composition set according to claim 8, wherein the nitrogen atom-containing ethylenically unsaturated monomer (B2) that is not a (meth)acrylate-based compound is selected from the group consisting of (meth)acrylamides and N-vinyllactams.

10. The model material composition set according to claim 7 , wherein the model material color composition comprises a monofunctional ethylenically unsaturated monomer and a di- or more functional ethylenically unsaturated monomer as the ethylenically unsaturated monomer (B).

11. The model material composition set according to claim 8 , wherein the model material color composition comprises a (meth)acrylate-based ethylenically unsaturated monomer having an aliphatic cyclic structure and/or an aromatic cyclic structure as the (meth)acrylate-based ethylenically unsaturated monomer (B1).

12. The model material composition set according to claim 7 , wherein a constitution of the model material color composition comprises cyan, magenta and yellow.

13. The model material composition set according to claim 12, wherein the constitution of the model material color composition further comprises white and/or black.

14. The model material composition set according to claim 1 , wherein both the model material clear composition and the model material color composition comprise a surface conditioner.

15. The model material composition set according to claim 14, wherein a content (% by mass) of the surface conditioner contained in the model material clear composition based on a total mass of the model material clear composition is larger than a content (% by mass) of the surface conditioner contained in the model material color composition based on the total mass of the model material color composition.

16. A composition set for material-jet optical shaping, comprising the model material clear composition according to claim 1 and a support material composition for shaping a support material by a material-jet optical shaping process.

17. A composition set for material-jet optical shaping, comprising the model material composition set according to claim 7 and a support material composition for shaping a support material by a material-jet optical shaping process.
